(19) United States
(12) Patent Application Publication
(10) Pub. No.: US 2014/0078898 A1
(43) Pub. Date: Mar. 20, 2014

(54) HANDING OFF BETWEEN NETWORKS WITH DIFFERENT RADIO ACCESS TECHNOLOGIES DURING A COMMUNICATION SESSION THAT IS ALLOCATED QUALITY OF SERVICE

(71) Applicant: QUALCOMM Incorporated, San Diego, CA (US)

(72) Inventors: Kirankumar ANCHAN, San Diego, CA (US); Arvind SANTHANAM, San Diego, CA (US); Karthika PALADUGU, San Diego, CA (US)

(73) Assignee: QUALCOMM Incorporated, San Diego, CA (US)

(21) Appl. No.: 14/030,457

(22) Filed: Sep. 18, 2013

Related U.S. Application Data
(60) Provisional application No. 61/703,039, filed on Sep. 19, 2012.

(51) Int. Cl. H04W 28/02; H04W 36/00

(52) U.S. Cl. CPC H04W 28/0268; H04W 36/00
USPC 370/230

(57) ABSTRACT

In an embodiment, a UE performs an IRAT handoff from a source network with a first RAT to a target network with a second RAT, and obtains a channel from the target network. The UE reports a level of QoS on the channel to a server via the target network. The server issues instructions to the UE and/or the target network for modifying the level of QoS in response to the report based on if the level of QoS is insufficient to support a particular type of communication session. In another embodiment, in conjunction with an IRAT handoff, the source network sends a handoff preparation message to the target network to facilitate the target network to initiate setup of a set of channels with a non-IMS application-specific QoS configuration for the UE on the target network in conjunction with the handoff.

### CLAIM OF PRIORITY UNDER 35 U.S.C. §119

The present application for Patent claims priority to Provisional Application No. 61/703,039, entitled “HANDING OFF BETWEEN LTE AND UMTS NETWORKS DURING A COMMUNICATION SESSION THAT IS ALLOCATED QUALITY OF SERVICE”, filed Sep. 19, 2012, by the same inventors as the subject application, assigned to the assignee hereof and hereby expressly incorporated by reference herein in its entirety.

### BACKGROUND OF THE INVENTION

1. Field of the Invention

Embodiments of the invention relate to an inter radio access technology (IRAT) handoff during a communication session that is allocated Quality of Service (QoS).

2. Description of the Related Art

Wireless communication systems have developed through various generations, including a first-generation analog wireless phone service (1G), a second-generation (2G) digital wireless phone service (including interim 2.5G and 2.75G networks) and third-generation (3G) and fourth-generation (4G) high speed data/Internet-capable wireless services. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

More recently, Long Term Evolution (LTE) has been developed as a wireless communications protocol for wireless communication of high-speed data for mobile phones and other data terminals. LTE is based on GSM, and includes contributions from various GSM-related protocols such as Enhanced Data rates for GSM Evolution (EDGE), and Universal Mobile Telecommunications System (UMTS) protocols such as High-Speed Packet Access (HSPA).

### SUMMARY

In an embodiment, a UE performs an IRAT handoff from a source network with a first RAT to a target network with a second RAT, and obtains a channel from the target network. The UE reports a level of QoS on the channel to a server via the target network. The server issues instructions to the UE and/or the target network for modifying the level of QoS in response to the report based on if the level of QoS is insufficient to support a particular type of communication session. In another embodiment, in conjunction with an IRAT handoff, the source network sends a handoff preparation message to the target network to facilitate the target network to initiate setup of a set of channels with a non-IMS application-specific QoS configuration for the UE on the target network in conjunction with the handoff.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 illustrates a high-level system architecture of a wireless communications system in accordance with an embodiment of the invention.

FIG. 2A illustrates an example configuration of a radio access network (RAN) and a packet-switched portion of a core network for a 1x EV-DO network in accordance with an embodiment of the invention.

FIG. 2B illustrates an example configuration of the RAN and a packet-switched portion of a General Packet Radio Service (GPRS) core network within a 3G UMTS W-CDMA system in accordance with an embodiment of the invention.

FIG. 2C illustrates another example configuration of the RAN and a packet-switched portion of a GPRS core network within a 3G UMTS W-CDMA system in accordance with an embodiment of the invention.

FIG. 2D illustrates an example configuration of the RAN and a packet-switched portion of the core network that is based on an Evolved Packet System (EPS) or Long Term Evolution (LTE) network in accordance with an embodiment of the invention.

FIG. 2E illustrates an example configuration of an enhanced High Rate Packet Data (HRPD) RAN connected to an EPS or LTE network and also a packet-switched portion of an HRPD core network in accordance with an embodiment of the invention.

FIG. 3 illustrates examples of user equipments (UEs) in accordance with embodiments of the invention.

FIG. 4 illustrates a communication device that includes logic configured to perform functionality in accordance with an embodiment of the invention.

FIGS. 5A-5B illustrate an ‘Always On’ Quality of Service (QoS) setup procedure for a particular Guaranteed Bit Rate (GBR) EPS bearer.

FIGS. 6A-6B show how access point name (APN) information can be exchanged during a QoS setup procedure for a particular GBR EPS bearer that is not ‘Always On’ in accordance with an embodiment of the invention.

FIG. 7A illustrates interfaces between the LTE core network from FIG. 2D as well as the UMTS or W-CDMA core network from FIGS. 2B-2C in accordance with an embodiment of the invention.

FIG. 7B illustrates interfaces between the LTE core network from FIG. 2D as well as the UMTS or W-CDMA core network from FIGS. 2B-2C in accordance with another embodiment of the invention.

FIG. 8 illustrates a process of handing off a given UE engaged in a communication session via a GBR QoS bearer over a UMTS core network to an LTE core network in accordance with an embodiment of the invention.

FIG. 9 illustrates a process of preparing for an LTE-to-UMTS handoff in accordance with an embodiment of the invention.

FIG. 10 illustrates a process of executing an LTE-to-UMTS handoff in accordance with an embodiment of the invention.

FIG. 11 illustrates a process of preparing for a UMTS-to-LTE handoff in accordance with an embodiment of the invention.

FIG. 12 illustrates a process of executing a UMTS-to-LTE handoff in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “subscriber terminal”, a “subscriber station”, a “user terminal” or UT, a “mobile terminal”, a “mobile station” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

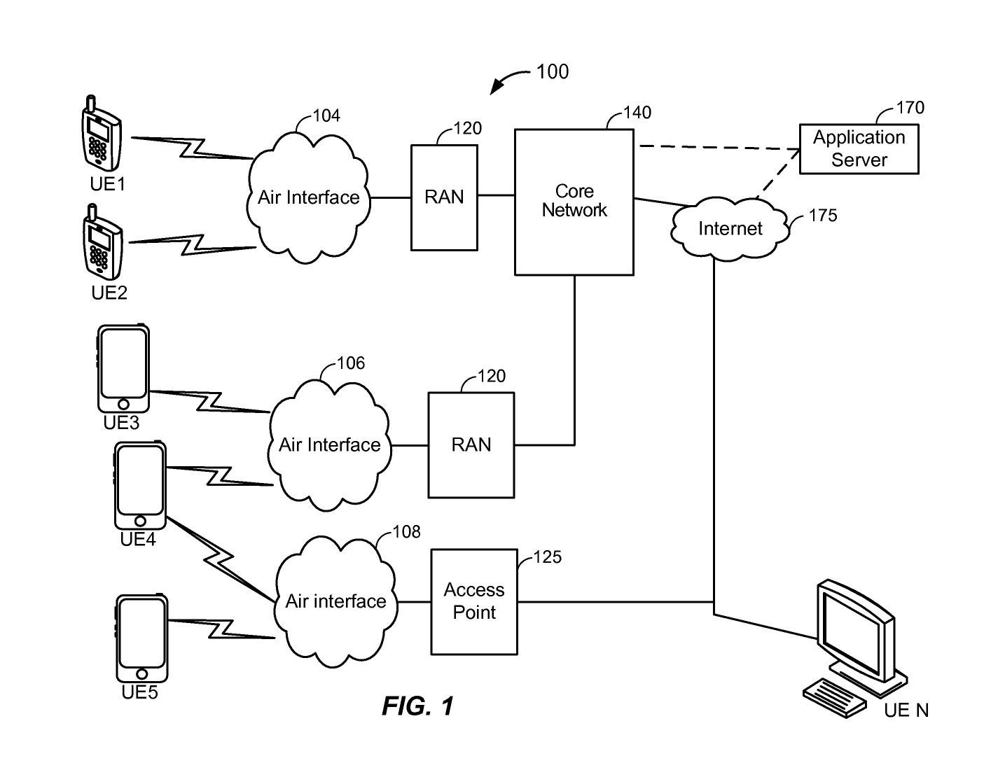

FIG. 1 illustrates a high-level system architecture of a wireless communications system 100 in accordance with an embodiment of the invention. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between UE N and UEs 1 . . . N via the core network 140. Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175.

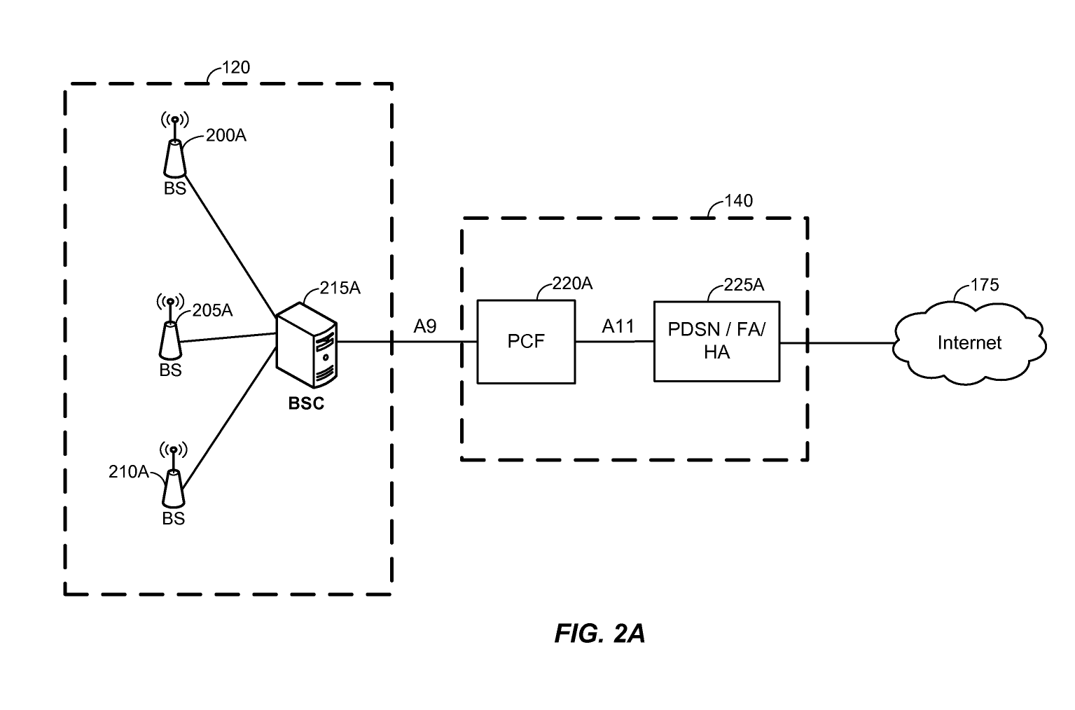

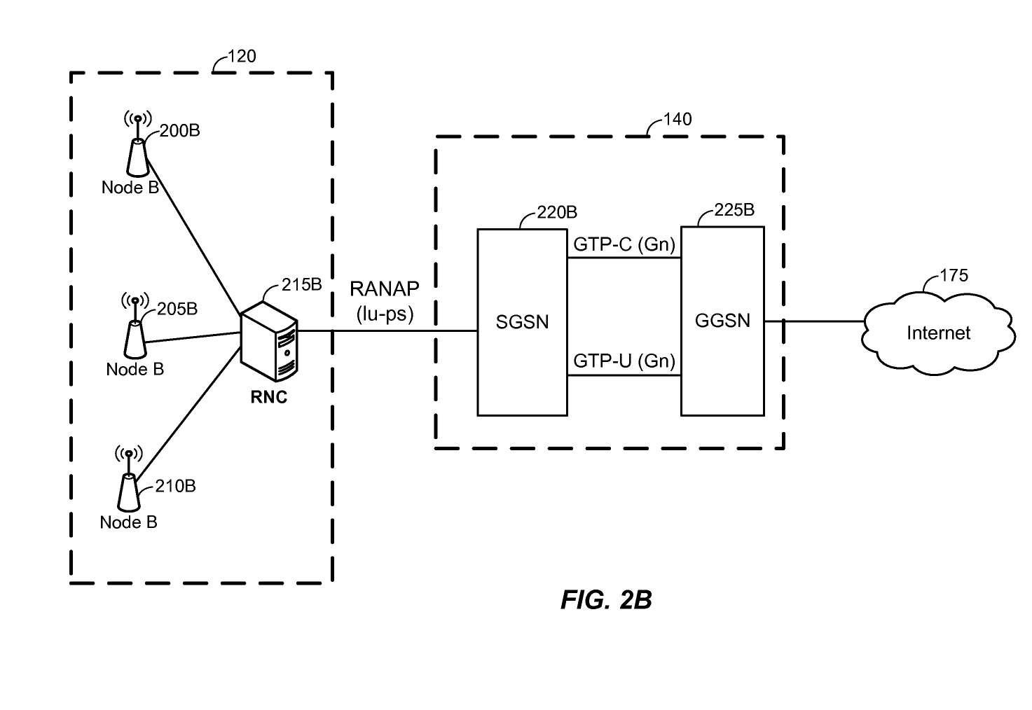

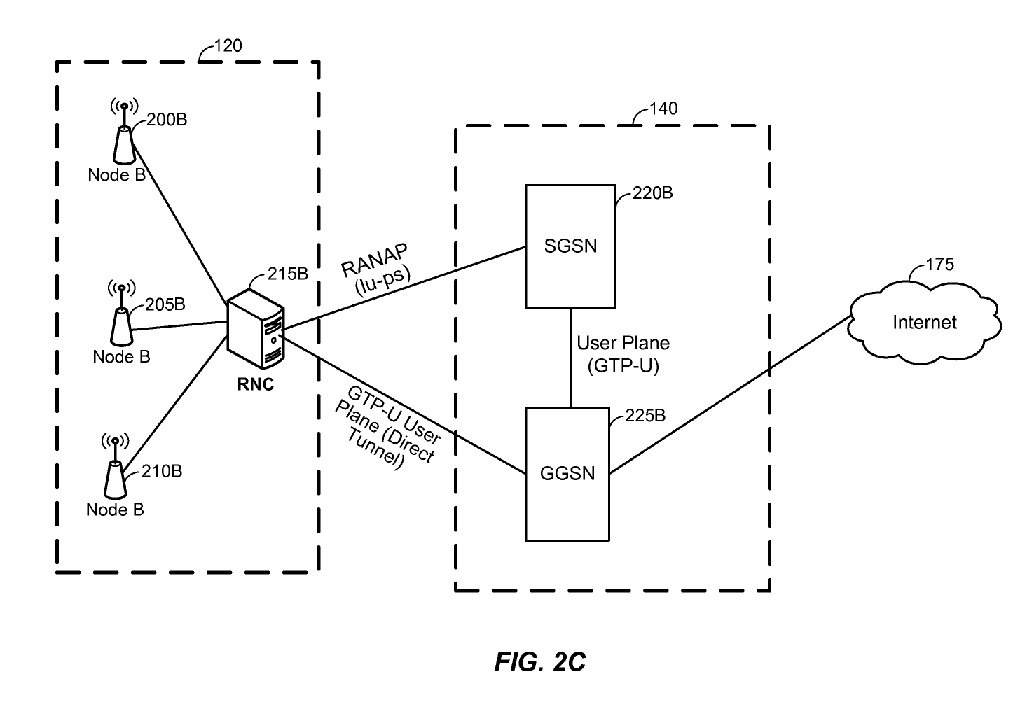

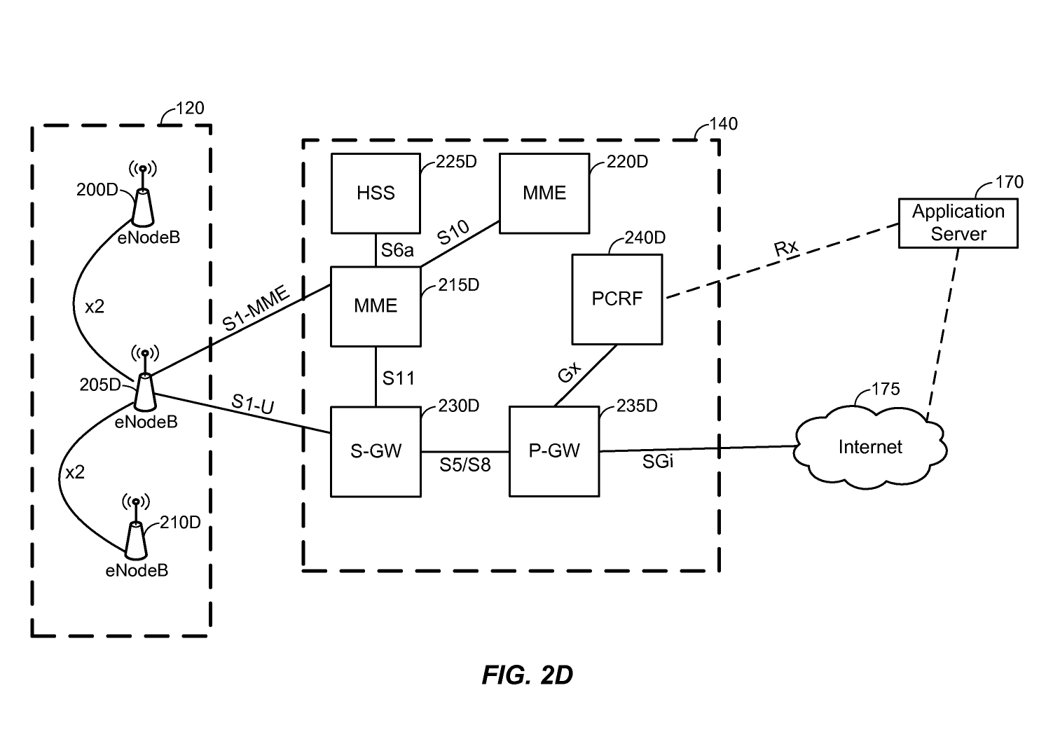

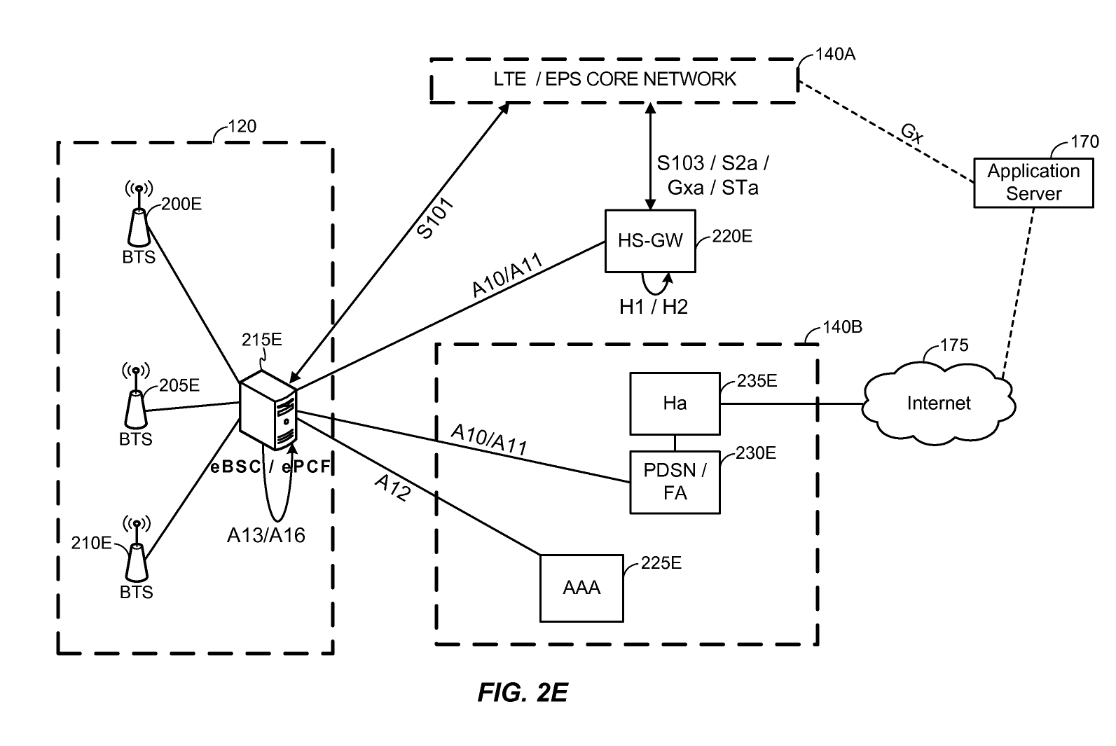

Examples of protocol-specific implementations for the RAN 120 and the core network 140 are provided below with respect to FIGS. 2A through 2E to help explain the wireless communications system 100 in more detail. In particular, the components of the RAN 120 and the core network 140 corresponds to components associated with supporting packet-switched (PS) communications, whereby legacy circuit-switched (CS) components may also be present in these networks, but any legacy CS-specific components are not shown explicitly in FIGS. 2A-2E.

FIG. 2A illustrates an example configuration of the RAN 120 and the core network 140 for packet-switched communications in a CDMA2000 1x Evolution-Data Optimized (EV-DO) network in accordance with an embodiment of the invention. Referring to FIG. 2A, the RAN 120 includes a plurality of base stations (BSs) 200A, 205A and 210A that are coupled to a base station controller (BSC) 215A over a wired backhaul interface. A group of BSs controlled by a single BSC is collectively referred to as a subnet. As will be appreciated by one of ordinary skill in the art, the RAN 120 can include multiple BSCs and subnets, and a single BSC is shown in FIG. 2A for the sake of convenience. The BSC 215A communicates with a packet control function (PCF) 220A within the core network 140 over an A9 connection. The PCF 220A performs certain processing functions for the BSC 215A related to packet data. The PCF 220A communicates with a Packet Data Serving Node (PDSN) 225A within the core network 140 over an A11 connection. The PDSN 225A has a variety of functions, including managing Point-to-Point (PPP) sessions, acting as a home agent (HA) and/or foreign agent (FA), and is similar in function to a Gateway General Packet Radio Service (GPRS) Support Node (GGSN) in GSM and UMTS networks (described below in more detail). The PDSN 225A connects the core network 140 to external IP networks, such as the Internet 175.

FIG. 2B illustrates an example configuration of the RAN 120 and a packet-switched portion of the core network 140 that is configured as a GPRS core network within a 3G UMTS W-CDMA system in accordance with an embodiment of the invention. Referring to FIG. 2B, the RAN 120 includes a plurality of Node Bs 200B, 205B and 210B that are coupled to a Radio Network Controller (RNC) 215B over a wired backhaul interface. Similar to 1x EV-DO networks, a group of Node Bs controlled by a single RNC is collectively referred to as a subnet. As will be appreciated by one of ordinary skill in the art, the RAN 120 can include multiple RNCs and subnets, and a single RNC is shown in FIG. 2B for the sake of convenience. The RNC 215B is responsible for signaling, establishing and tearing down bearer channels (i.e., data channels) between a Serving GRPS Support Node (SGSN) 220B in the core network 140 and UEs served by the RAN 120. If link layer encryption is enabled, the RNC 215B also encrypts the content before forwarding it to the RAN 120 for transmission over an air interface. The function of the RNC 215B is well-known in the art and will not be discussed further for the sake of brevity.

In FIG. 2B, the core network 140 includes the above-noted SGSN 220B (and potentially a number of other SGSNs as well) and a GGSN 225B. Generally, GPRS is a protocol used in GSM for routing IP packets. The GPRS core network (e.g., the GGSN 225B and one or more SGSNs 220B) is the centralized part of the GPRS system and also provides support for W-CDMA based 3G access networks. The GPRS core network is an integrated part of the GSM core network (i.e., the core network 140) that provides mobility management, session management and transport for IP packet services in GSM and W-CDMA networks.

The GPRS Tunneling Protocol (GTP) is the defining IP protocol of the GPRS core network. The GTP is the protocol which allows end users (e.g., UEs) of a GSM or W-CDMA network to move from place to place while continuing to connect to the Internet 175 as if from one location at the GGSN 225B. This is achieved by transferring the respective UE's data from the UE's current SGSN 220B to the GGSN 225B, which is handling the respective UE's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2B, the GGSN 225B acts as an interface between a GPRS backbone network (not shown) and the Internet 175. The GGSN 225B extracts packet data with associated a packet data protocol (PDP) format (e.g., IP or PPP) from GPRS packets coming from the SGSN 220B, and sends the packets out on a corresponding packet data network. In the other direction, the incoming data packets are directed by the GGSN connected UE to the SGSN 220B which manages and controls the Radio Access Bearer (RAB) of a target UE served by the RAN 120. Thereby, the GGSN 225B stores the current SGSN address of the target UE and its associated profile in a location register (e.g., within a PDP context). The GGSN 225B is responsible for IP address assignment and is the default router for a connected UE. The GGSN 225B also performs authentication and charging functions.

The SGSN 220B is representative of one of many SGSNs within the core network 140, in an example. Each SGSN is responsible for the delivery of data packets from and to the UEs within an associated geographical service area. The tasks of the SGSN 220B includes packet routing and transfer, mobility management (e.g., attach/detach and location management), logical link management, and authentication and charging functions. The location register of the SGSN 220B stores location information (e.g., current cell, current VLR) and user profiles (e.g., IMSI, PDP address(es) used in the packet data network) of all GPRS users registered with the SGSN 220B, for example, within one or more PDP contexts for each user or UE. Thus, SGSNs 220B are responsible for (i) de-tunneling downlink GTP packets from the GGSN 225B, (ii) uplink tunnel IP packets toward the GGSN 225B, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in UMTS system architecture) communicates with the SGSN 220B via a Radio Access Network Application Part (RANAP) protocol. RANAP operates over a Iu interface (Iu-ps), with a transmission protocol such as Frame Relay or IP. The SGSN 220B communicates with the GGSN 225B via a Gn interface, which is an IP-based interface between SGSN 220B and other SGSNs (not shown) and internal GGSNs (not shown), and uses the GTP protocol defined above (e.g., GTP-U, GTP-C, GTP′, etc.). In the embodiment of FIG. 2B, the Gn between the SGSN 220B and the GGSN 225B carries both the GTP-C and the GTP-U. While not shown in FIG. 2B, the Gn interface is also used by the Domain Name System (DNS). The GGSN 225B is connected to a Public Data Network (PDN) (not shown), and in turn to the Internet 175, via a Gi interface with IP protocols either directly or through a Wireless Application Protocol (WAP) gateway.

FIG. 2C illustrates another example configuration of the RAN 120 and a packet-switched portion of the core network 140 that is configured as a GPRS core network within a 3G UMTS W-CDMA system in accordance with an embodiment of the invention. Similar to FIG. 2B, the core network 140 includes the SGSN 220B and the GGSN 225B. However, in FIG. 2C, Direct Tunnel is an optional function in Iu mode that allows the SGSN 220B to establish a direct user plane tunnel, GTP-U, between the RAN 120 and the GGSN 225B within a PS domain. A Direct Tunnel capable SGSN, such as SGSN 220B in FIG. 2C, can be configured on a per GGSN and per RNC basis whether or not the SGSN 220B can use a direct user plane connection. The SGSN 220B in FIG. 2C handles the control plane signaling and makes the decision of when to establish Direct Tunnel When the RAB assigned for a PDP context is released (i.e. the PDP context is preserved) the GTP-U tunnel is established between the GGSN 225B and SGSN 220B in order to be able to handle the downlink packets.

FIG. 2D illustrates an example configuration of the RAN 120 and a packet-switched portion of the core network 140 based on an Evolved Packet System (EPS) or LTE network, in accordance with an embodiment of the invention. Referring to FIG. 2D, unlike the RAN 120 shown in FIGS. 2B-2C, the RAN 120 in the EPS/LTE network is configured with a plurality of Evolved Node Bs (ENodeBs or eNBs) 200D, 205D and 210D, without the RNC 215B from FIGS. 2B-2C. This is because ENodeBs in EPS/LTE networks do not require a separate controller (i.e., the RNC 215B) within the RAN 120 to communicate with the core network 140. In other words, some of the functionality of the RNC 215B from FIGS. 2B-2C is built into each respective eNodeB of the RAN 120 in FIG. 2D.

In FIG. 2D, the core network 140 includes a plurality of Mobility Management Entities (MMES) 215D and 220D, a Home Subscriber Server (HSS) 225D, a Serving Gateway (S-GW) 230D, a Packet Data Network Gateway (P-GW) 235D and a Policy and Charging Rules Function (PCRF) 240D. Network interfaces between these components, the RAN 120 and the Internet 175 are illustrated in FIG. 2D and are defined in Table 1 (below) as follows:

TABLE 1
EPS/LTE Core Network Connection Definitions

| Network Interface | Description |
|---|---|
| S1-MME | Reference point for the control plane protocol between RAN 120 |
| | and MME 215D. |
| S1-U | Reference point between RAN 120 and S-GW 230D for the per |
| | bearer user plane tunneling and inter-eNodeB path switching |
| | during handover. |
| S5 | Provides user plane tunneling and tunnel management between S- |
| | GW 230D and P-GW 235D. It is used for S-GW relocation due to |
| | UE mobility and if the S-GW 230D needs to connect to a non- |
| | collocated P-GW for the required PDN connectivity. |
| S6a | Enables transfer of subscription and authentication data for |
| | authenticating/authorizing user access to the evolved system |
| | (Authentication, Authorization, and Accounting [AAA] interface) |
| | between MME 215D and HSS 225D. |
| Gx | Provides transfer of Quality of Service (QoS) policy and charging |
| | rules from PCRF 240D to Policy a Charging Enforcement |
| | Function (PCEF) component (not shown) in the P-GW 235D. |
| S8 | Inter-PLMN reference point providing user and control plane |
| | between the S-GW 230D in a Visited Public Land Mobile |
| | Network (VPLMN) and the P-GW 235D in a Home Public Land |
| | Mobile Network (HPLMN). S8 is the inter-PLMN variant of S5. |
| S10 | Reference point between MMEs 215D and 220D for MME |
| | relocation and MME to MME information transfer. |
| S11 | Reference point between MME 215D and S-GW 230D. |
| SGi | Reference point between the P-GW 235D and the packet data |
| | network, shown in FIG. 2D as the Internet 175. The Packet data |
| | network may be an operator external public or private packet data |
| | network or an intra-operator packet data network (e.g., for |
| | provision of IMS services). This reference point corresponds to Gi |
| | for 3GPP accesses. |
| X2 | Reference point between two different eNodeBs used for UE |
| | handoffs. |
| Rx | Reference point between the PCRF 240D and an application |
| | function (AF) that is used to exchanged application-level session |
| | information, where the AF is represented in FIG. 1 by the |
| | application server 170. |

A high-level description of the components shown in the RAN 120 and core network 140 of FIG. 2D will now be described. However, these components are each well-known in the art from various 3GPP TS standards, and the description contained herein is not intended to be an exhaustive description of all functionalities performed by these components.

Referring to FIG. 2D, the MMEs 215D and 220D are configured to manage the control plane signaling for the EPS bearers. MME functions include: Non-Access Stratum (NAS) signaling, NAS signaling security, Mobility management for inter- and intra-technology handovers, P-GW and S-GW selection, and MME selection for handovers with MME change.

Referring to FIG. 2D, the S-GW 230D is the gateway that terminates the interface toward the RAN 120. For each UE associated with the core network 140 for an EPS-based system, at a given point of time, there is a single S-GW. The functions of the S-GW 230D, for both the GTP-based and the Proxy Mobile IPv6 (PMIP)-based S5/S8, include: Mobility anchor point, Packet routing and forwarding, and setting the DiffServ Code Point (DSCP) based on a QoS Class Identifier (QCI) of the associated EPS bearer.

Referring to FIG. 2D, the P-GW 235D is the gateway that terminates the SGi interface toward the Packet Data Network (PDN), e.g., the Internet 175. If a UE is accessing multiple PDNs, there may be more than one P-GW for that UE; however, a mix of S5/S8 connectivity and Gn/Gp connectivity is not typically supported for that UE simultaneously. P-GW functions include for both the GTP-based S5/S8: Packet filtering (by deep packet inspection), UE IP address allocation, setting the DSCP based on the QCI of the associated EPS bearer, accounting for inter operator charging, uplink (UL) and downlink (DL) bearer binding as defined in 3GPP TS 23.203, UL bearer binding verification as defined in 3GPP TS 23.203. The P-GW 235D provides PDN connectivity to both GSM/EDGE Radio Access Network (GERAN)/UTRAN only UEs and E-UTRAN-capable UEs using any of E-UTRAN, GERAN, or UTRAN. The P-GW 235D provides PDN connectivity to E-UTRAN capable UEs using E-UTRAN only over the S5/S8 interface.

Referring to FIG. 2D, the PCRF 240D is the policy and charging control element of the EPS-based core network 140. In a non-roaming scenario, there is a single PCRF in the HPLMN associated with a UE's Internet Protocol Connectivity Access Network (IP-CAN) session. The PCRF terminates the Rx interface and the Gx interface. In a roaming scenario with local breakout of traffic, there may be two PCRFs associated with a UE's IP-CAN session: A Home PCRF (H-PCRF) is a PCRF that resides within a HPLMN, and a Visited PCRF (V-PCRF) is a PCRF that resides within a visited VPLMN. PCRF is described in more detail in 3GPP TS 23.203, and as such will not be described further for the sake of brevity. In FIG. 2D, the application server 170 (e.g., which can be referred to as the AF in 3GPP terminology) is shown as connected to the core network 140 via the Internet 175, or alternatively to the PCRF 240D directly via an Rx interface. Generally, the application server 170 (or AF) is an element offering applications that use IP bearer resources with the core network (e.g. UMTS PS domain/GPRS domain resources/LTE PS data services). One example of an application function is the Proxy-Call Session Control Function (P-CSCF) of the IP Multimedia Subsystem (IMS) Core Network sub system. The AF uses the Rx reference point to provide session information to the PCRF 240D. Any other application server offering IP data services over cellular network can also be connected to the PCRF 240D via the Rx reference point.

FIG. 2E illustrates an example of the RAN 120 configured as an enhanced High Rate Packet Data (HRPD) RAN connected to an EPS or LTE network 140A and also a packet-switched portion of an HRPD core network 140B in accordance with an embodiment of the invention. The core network 140A is an EPS or LTE core network, similar to the core network described above with respect to FIG. 2D.

In FIG. 2E, the eHRPD RAN includes a plurality of base transceiver stations (BTSs) 200E, 205E and 210E, which are connected to an enhanced BSC (eBSC) and enhanced PCF (ePCF) 215E. The eBSC/ePCF 215E can connect to one of the MMEs 215D or 220D within the EPS core network 140A over an S101 interface, and to an HRPD serving gateway (HSGW) 220E over A10 and/or A11 interfaces for interfacing with other entities in the EPS core network 140A (e.g., the S-GW 230D over an S103 interface, the P-GW 235D over an S2a interface, the PCRF 240D over a Gxa interface, a 3GPP AAA server (not shown explicitly in FIG. 2D) over an STa interface, etc.). The HSGW 220E is defined in 3GPP2 to provide the interworking between HRPD networks and EPS/LTE networks. As will be appreciated, the eHRPD RAN and the HSGW 220E are configured with interface functionality to EPC/LTE networks that is not available in legacy HRPD networks.

Turning back to the eHRPD RAN, in addition to interfacing with the EPS/LTE network 140A, the eHRPD RAN can also interface with legacy HRPD networks such as HRPD network 140B. As will be appreciated the HRPD network 140B is an example implementation of a legacy HRPD network, such as the EV-DO network from FIG. 2A. For example, the eBSC/ePCF 215E can interface with an authentication, authorization and accounting (AAA) server 225E via an A12 interface, or to a PDSN/FA 230E via an A10 or A11 interface. The PDSN/FA 230E in turn connects to HA 235A, through which the Internet 175 can be accessed. In FIG. 2E, certain interfaces (e.g., A13, A16, H1, H2, etc.) are not described explicitly but are shown for completeness and would be understood by one of ordinary skill in the art familiar with HRPD or eHRPD.

Referring to FIGS. 2B-2E, it will be appreciated that LTE core networks (e.g., FIG. 2D) and HRPD core networks that interface with eHRPD RANs and HSGWs (e.g., FIG. 2E) can support network-initiated Quality of Service (QoS) (e.g., by the P-GW, GGSN, SGSN, etc.) in certain cases.

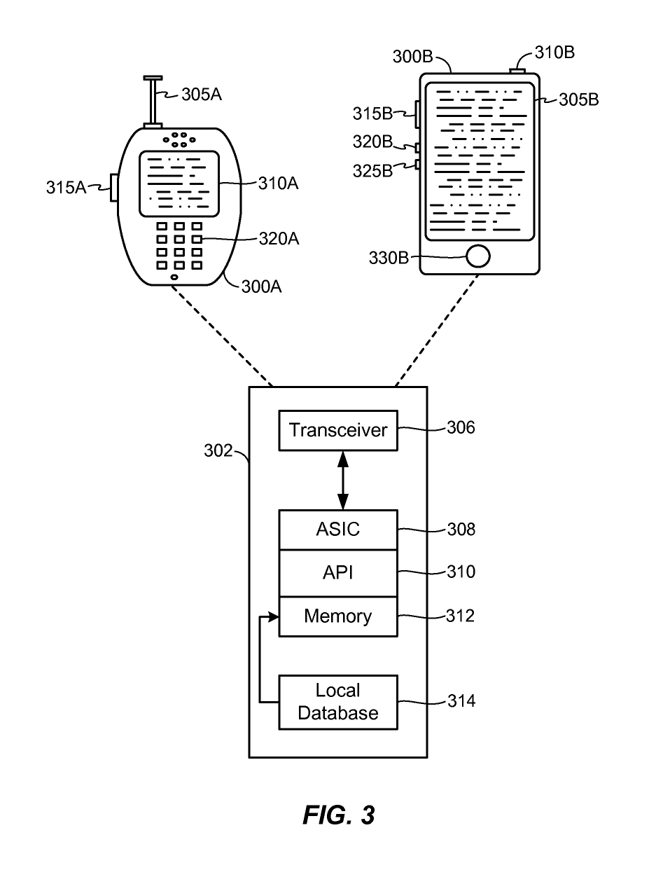

FIG. 3 illustrates examples of UEs in accordance with embodiments of the invention. Referring to FIG. 3, UE 300A is illustrated as a calling telephone and UE 300B is illustrated as a touchscreen device (e.g., a smart phone, a tablet computer, etc.). As shown in FIG. 3, an external casing of UE 300A is configured with an antenna 305A, display 310A, at least one button 315A (e.g., a PTT button, a power button, a volume control button, etc.) and a keypad 320A among other components, as is known in the art. Also, an external casing of UE 300B is configured with a touchscreen display 305B, peripheral buttons 310B, 315B, 320B and 325B (e.g., a power control button, a volume or vibrate control button, an airplane mode toggle button, etc.), at least one front-panel button 330B (e.g., a Home button, etc.), among other components, as is known in the art. While not shown explicitly as part of UE 300B, the UE 300B can include one or more external antennas and/or one or more integrated antennas that are built into the external casing of UE 300B, including but not limited to WiFi antennas, cellular antennas, satellite position system (SPS) antennas (e.g., global positioning system (GPS) antennas), and so on.

While internal components of UEs such as the UEs 300A and 300B can be embodied with different hardware configurations, a basic high-level UE configuration for internal hardware components is shown as platform 302 in FIG. 3. The platform 302 can receive and execute software applications, data and/or commands transmitted from the RAN 120 that may ultimately come from the core network 140, the Internet 175 and/or other remote servers and networks (e.g., application server 170, web URLs, etc.). The platform 302 can also independently execute locally stored applications without RAN interaction. The platform 302 can include a transceiver 306 operably coupled to an application specific integrated circuit (ASIC) 308, or other processor, microprocessor, logic circuit, or other data processing device. The ASIC 308 or other processor executes the application programming interface (API) 310 layer that interfaces with any resident programs in the memory 312 of the wireless device. The memory 312 can be comprised of read-only or random-access memory (RAM and ROM), EEPROM, flash cards, or any memory common to computer platforms. The platform 302 also can include a local database 314 that can store applications not actively used in memory 312, as well as other data. The local database 314 is typically a flash memory cell, but can be any secondary storage device as known in the art, such as magnetic media, EEPROM, optical media, tape, soft or hard disk, or the like.

Accordingly, an embodiment of the invention can include a UE (e.g., UE 300A, 300B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 308, memory 312, API 310 and local database 314 may all be used cooperatively to load, store and execute the various functions disclosed herein and thus the logic to perform these functions may be distributed over various elements. Alternatively, the functionality could be incorporated into one discrete component. Therefore, the features of the UEs 300A and 300B in FIG. 3 are to be considered merely illustrative and the invention is not limited to the illustrated features or arrangement.

The wireless communication between the UEs 300A and/or 300B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

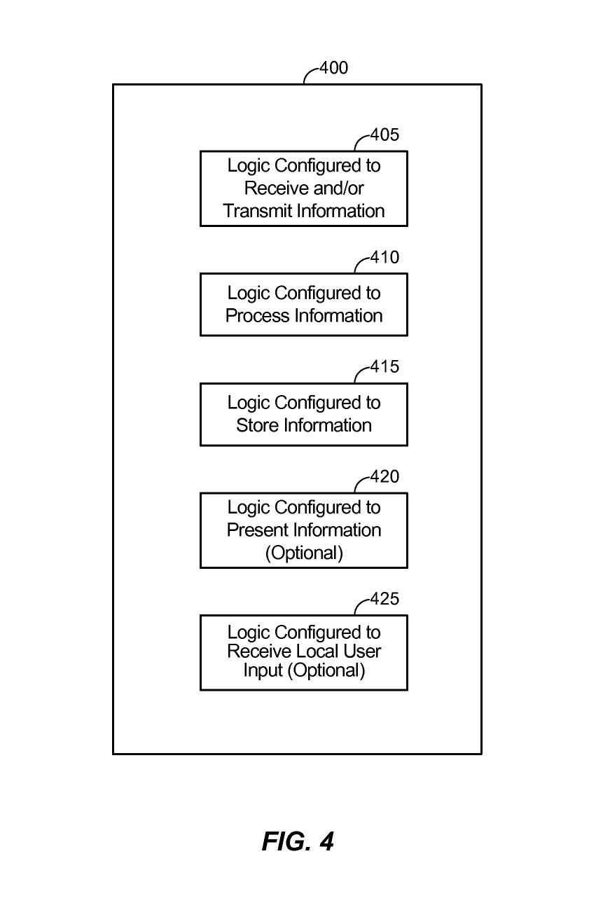

FIG. 4 illustrates a communication device 400 that includes logic configured to perform functionality. The communication device 400 can correspond to any of the above-noted communication devices, including but not limited to UEs 300A or 300B, any component of the RAN 120 (e.g., BSs 200A through 210A, BSC 215A, Node Bs 200B through 210B, RNC 215B, eNodeBs 200D through 210D, etc.), any component of the core network 140 (e.g., PCF 220A, PDSN 225A, SGSN 220B, GGSN 225B, MME 215D or 220D, HSS 225D, S-GW 230D, P-GW 235D, PCRF 240D), any components coupled with the core network 140 and/or the Internet 175 (e.g., the application server 170), and so on. Thus, communication device 400 can correspond to any electronic device that is configured to communicate with (or facilitate communication with) one or more other entities over the wireless communications system 100 of FIG. 1.

Referring to FIG. 4, the communication device 400 includes logic configured to receive and/or transmit information 405. In an example, if the communication device 400 corresponds to a wireless communications device (e.g., UE 300A or 300B, one of BSs 200A through 210A, one of Node Bs 200B through 210B, one of eNodeBs 200D through 210D, etc.), the logic configured to receive and/or transmit information 405 can include a wireless communications interface (e.g., Bluetooth, WiFi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 405 can correspond to a wired communications interface (e.g., a serial connection, a USB or Firewire connection, an Ethernet connection through which the Internet 175 can be accessed, etc.). Thus, if the communication device 400 corresponds to some type of network-based server (e.g., PDSN, SGSN, GGSN, S-GW, P-GW, MME, HSS, PCRF, the application 170, etc.), the logic configured to receive and/or transmit information 405 can correspond to an Ethernet card, in an example, that connects the network-based server to other communication entities via an Ethernet protocol. In a further example, the logic configured to receive and/or transmit information 405 can include sensory or measurement hardware by which the communication device 400 can monitor its local environment (e.g., an accelerometer, a temperature sensor, a light sensor, an antenna for monitoring local RF signals, etc.). The logic configured to receive and/or transmit information 405 can also include software that, when executed, permits the associated hardware of the logic configured to receive and/or transmit information 405 to perform its reception and/or transmission function(s). However, the logic configured to receive and/or transmit information 405 does not correspond to software alone, and the logic configured to receive and/or transmit information 405 relies at least in part upon hardware to achieve its functionality.

Referring to FIG. 4, the communication device 400 further includes logic configured to process information 410. In an example, the logic configured to process information 410 can include at least a processor. Example implementations of the type of processing that can be performed by the logic configured to process information 410 includes but is not limited to performing determinations, establishing connections, making selections between different information options, performing evaluations related to data, interacting with sensors coupled to the communication device 400 to perform measurement operations, converting information from one format to another (e.g., between different protocols such as .wmv to .avi, etc.), and so on. For example, the processor included in the logic configured to process information 410 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The logic configured to process information 410 can also include software that, when executed, permits the associated hardware of the logic configured to process information 410 to perform its processing function(s). However, the logic configured to process information 410 does not correspond to software alone, and the logic configured to process information 410 relies at least in part upon hardware to achieve its functionality.

Referring to FIG. 4, the communication device 400 further includes logic configured to store information 415. In an example, the logic configured to store information 415 can include at least a non-transitory memory and associated hardware (e.g., a memory controller, etc.). For example, the non-transitory memory included in the logic configured to store information 415 can correspond to RAM memory, flash memory, ROM memory, EPROM memory, EEPROM memory, registers, hard disk, a removable disk, a CD-ROM, or any other form of storage medium known in the art. The logic configured to store information 415 can also include software that, when executed, permits the associated hardware of the logic configured to store information 415 to perform its storage function(s). However, the logic configured to store information 415 does not correspond to software alone, and the logic configured to store information 415 relies at least in part upon hardware to achieve its functionality.

Referring to FIG. 4, the communication device 400 further optionally includes logic configured to present information 420. In an example, the logic configured to present information 420 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 400. For example, if the communication device 400 corresponds to UE 300A or UE 300B as shown in FIG. 3, the logic configured to present information 420 can include the display 310A of UE 300A or the touchscreen display 305B of UE 300B. In a further example, the logic configured to present information 420 can be omitted for certain communication devices, such as network communication devices that do not have a local user (e.g., network switches or routers, remote servers, etc.). The logic configured to present information 420 can also include software that, when executed, permits the associated hardware of the logic configured to present information 420 to perform its presentation function(s). However, the logic configured to present information 420 does not correspond to software alone, and the logic configured to present information 420 relies at least in part upon hardware to achieve its functionality.

Referring to FIG. 4, the communication device 400 further optionally includes logic configured to receive local user input 425. In an example, the logic configured to receive local user input 425 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 400. For example, if the communication device 400 corresponds to UE 300A or UE 300B as shown in FIG. 3, the logic configured to receive local user input 425 can include the keypad 320A, any of the buttons 315A or 310B through 325B, the touchscreen display 305B, etc. In a further example, the logic configured to receive local user input 425 can be omitted for certain communication devices, such as network communication devices that do not have a local user (e.g., network switches or routers, remote servers, etc.). The logic configured to receive local user input 425 can also include software that, when executed, permits the associated hardware of the logic configured to receive local user input 425 to perform its input reception function(s). However, the logic configured to receive local user input 425 does not correspond to software alone, and the logic configured to receive local user input 425 relies at least in part upon hardware to achieve its functionality.

Referring to FIG. 4, while the configured logics of 405 through 425 are shown as separate or distinct blocks in FIG. 4, it will be appreciated that the hardware and/or software by which the respective configured logic performs its functionality can overlap in part. For example, any software used to facilitate the functionality of the configured logics of 405 through 425 can be stored in the non-transitory memory associated with the logic configured to store information 415, such that the configured logics of 405 through 425 each performs their functionality (i.e., in this case, software execution) based in part upon the operation of software stored by the logic configured to store information 415. Likewise, hardware that is directly associated with one of the configured logics can be borrowed or used by other configured logics from time to time. For example, the processor of the logic configured to process information 410 can format data into an appropriate format before being transmitted by the logic configured to receive and/or transmit information 405, such that the logic configured to receive and/or transmit information 405 performs its functionality (i.e., in this case, transmission of data) based in part upon the operation of hardware (i.e., the processor) associated with the logic configured to process information 410.

Generally, unless stated otherwise explicitly, the phrase “logic configured to” as used throughout this disclosure is intended to invoke an embodiment that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the embodiments described below in more detail.

Sessions that operate over networks such as 1x EV-DO in FIG. 2A, UMTS-based W-CDMA in FIGS. 2B-2C, LTE in FIG. 2D and eHRPD in FIG. 2E can be supported on channels (e.g. RABs, flows, etc.) for which a guaranteed quality level is reserved, which is referred to as Quality of Service (QoS). For example, establishing a given level of QoS on a particular channel may provide one or more of a minimum guaranteed bit rate (GBR) on that channel, a maximum delay, jitter, latency, bit error rate (BER), and so on. QoS resources can be reserved (or setup) for channels associated with real-time or streaming communication sessions, such as Voice-over IP (VoIP) sessions, group communication sessions (e.g., PTT sessions, etc.), online games, IP TV, and so on, to help ensure seamless end-to-end packet transfer for these sessions.

GBR QoS EPS bearers in LTE can be associated with a preconfigured QCI for “Conversational Voice” traffic, denoted as QCI ‘1’, which is associated with a specific QoS configuration for the associated GBR EPS bearers. Any VoIP application engaging in VoIP sessions over the LTE core network can invoke QCI ‘1’. Generally, different multimedia services that interact with the LTE core network are assigned different APNs for their operation over the LTE core network. For example, IP Multimedia Subsystem (IMS) applications use an IMS-specific APN, whereas a non-IMS application (denoted herein as App*) can used an App*-specific APN, and so on.

Voice Over LTE (VoLTE) is an IMS-based VoIP solution for LTE that uses QCI ‘1’. A GBR bearer with QCI ‘1’ is configured for VoLTE with the following requirements:
Single Radio Voice Call Continuity (SRVCC): Voice call continuity between IMS over PS access and CS access (over 1x or UMTS) for calls that are anchored in IMS when the UE is capable of transmitting/receiving on only one of those access networks at a given time;
GBR bearer brought up on demand for VoLTE call (no GBR S5 connections maintained in Always On state). The LTE core network maintains the S5 connection between the S-GW 230D and P-GW 240D for default EPS bearers (i.e., EPS bearers that are not allocated GBR QoS) corresponding to each PDN connection in an ‘Always On’ state, such that the non-GBR QoS EPS bearer is maintained (not released) when the UE transitions from an RRC-Connected state to an RRC-Idle state. The reason for this is that maintaining default EPS Bearer connections in active states does not impact the capacity of the LTE core network. However, for QoS bearers with GBR, LTE core networks typically release the S5 connections when an associated UE is determined to transition from the RRC-Connected state to the RRC-Idle state to conserve resources, because maintaining the S5 connections for GBR EPS bearers consumes core network resources which limit the capacity of the LTE core network’;
Configuring semi persistent scheduling (SPS) for the GBR bearer with QCI ‘1’;
Using specific Connected Mode Discontinuous Reception (CDRX) settings for UEs configured for the GBR bearer with QCI ‘1’; and
Enabling Robust Header Compression (RoHC) for the GBR bearer with QCI ‘1’

However, the typical VoLTE parameters for which QCI ‘1’ is configured may not be suitable for other VoIP applications which use the GBR bearer with QCI ‘1’ as well, but with the traffic model and network architecture different than VoLTE. For example, App* may correspond to a half-duplex VoIP application with a traffic model that can diverge from VoLTE. For instance, (i) App* can bundle more than 1 (e.g. 6) vocoder frames per RTP packet, such that SPS is not efficient for App* traffic, and (ii) as the RTP/UDP/IP header overhead per RTP packet can be minimal for App* (due to the bundling factor of 6), RoHC is less critical and it may thereby not be imperative not enable RoHC to avoid the compressing/decompressing delays.

Conventionally, the eNodeB 205D is aware of the QCI for a particular GBR EPS bearer, such as QCI ‘1’ for VoLTE, but the eNodeB 205D is not aware of the APN for the GBR EPS bearer associated with that QCI. Thus, the eNodeB 205D generally cannot distinguish between a VoLTE session allocated QCI ‘1’ and an App* session (or other non-IMS session) allocated QCI ‘1’. Accordingly, applying application-specific (or APN-specific) QCI configurations in LTE networks can be difficult.

Embodiments of the invention are directed to a number of different implementations for selectively loading application-specific features/support parameter configurations at LTE network components.

In a first embodiment of the invention, the LTE standard permits QCIs in a range between 128-255 to be reserved, and one or more of the QCIs in this range can be reserved with an application-specific QCI configuration (e.g., for App*). A given QCI (QCI_{App}*) can thereby be reserved for App*, such that when a GBR EPS bearer associated with QCI_{App}* is activated on a given UE, the eNodeB 205D does not perform SRVCC, does not enable RoHC, etc., and the P-GW 235D and S-GW 235D maintain the GBR EPS bearer's S5 connection in an ‘Always On” state (even when the given UE is in RCC-Idle state), although its air interface resources may be permitted to lapse in RCC-Idle state. As will be appreciated, this embodiment requires the LTE standard to be updated to recognize QCI_{App}*, it may be difficult for each LTE network component to distinguish between application-specific traffic and to reserve a different QCI for each application type, and even if some additional QCIs are defined for non-IMS based VoIP applications (such as App*), different of these applications may be assigned to the same QCI even if the different non-IMS based VoIP applications have different requirements from each other.

In a second embodiment of the invention, LTE network components (e.g., eNodeB, S-GW, P-GW, etc.) can use Differentiated Services Code Point (DSCP) marking (assuming each voice application on the UE marks the IP header of the media packets with a DSCP different than IMS solution) to identify when traffic is active for a non-IMS solution, and, each of the LTE network component can activate features/support parameter configuration separately for each application based on the DSCP marking. As will be appreciated, VoIP applications in this embodiment may attempt to use Expedited forwarding and thus uniquely identifying each application-type via DSCP marking may be difficult.

In a third embodiment of the invention, LTE network components (e.g., eNodeB, S-GW, P-GW, etc.) can use a combination of QCI and APN to identify the application (e.g., App*, etc.) using the GBR EPS bearer and then activate application-specific features/support parameter configuration separately for each application based on its unique QCI and APN combination. As noted above, the eNodeB 205D does not typically have access to the APN information of a GBR EPS bearer, so additional procedures can be adopted into the LTE standard to pass the APN information of the GBR EPS bearer to the eNodeB 205D. For example, the MME 215D can pass the APN information to the eNodeB 205D. Also, operators can define rules at each entity on what features/configuration are applicable for a specific QCI+APN combination. As will be appreciated, this embodiment provides APN-specific feature support, parameter configuration granularity and flexibility for operators in defining the service performance for each application. It will also be appreciated that this embodiment requires the LTE standard to be modified to accommodate a new APN field in messaging between the MME 215D and the eNodeB 205D, and also between different eNodeBs. Several of the embodiments below are described with respect to this third embodiment, which may be referred to as the QCI+APN embodiment, because a combination of the QCI and APN are used to signal the appropriate configuration to be loaded for a particular QoS bearer. However, it will be readily appreciated that certain of the embodiments described below could be modified based on the first and/or second embodiments for identifying the appropriate application-specific configuration, and the QCI+APN references are provided mainly for convenience of explanation.

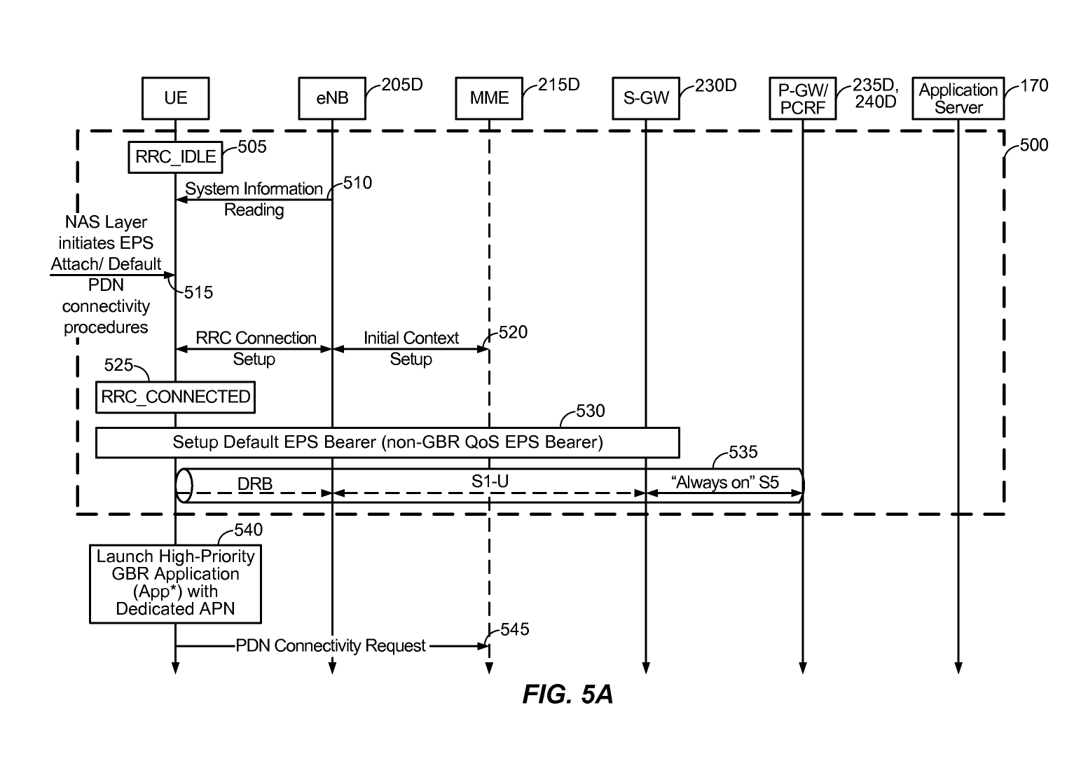

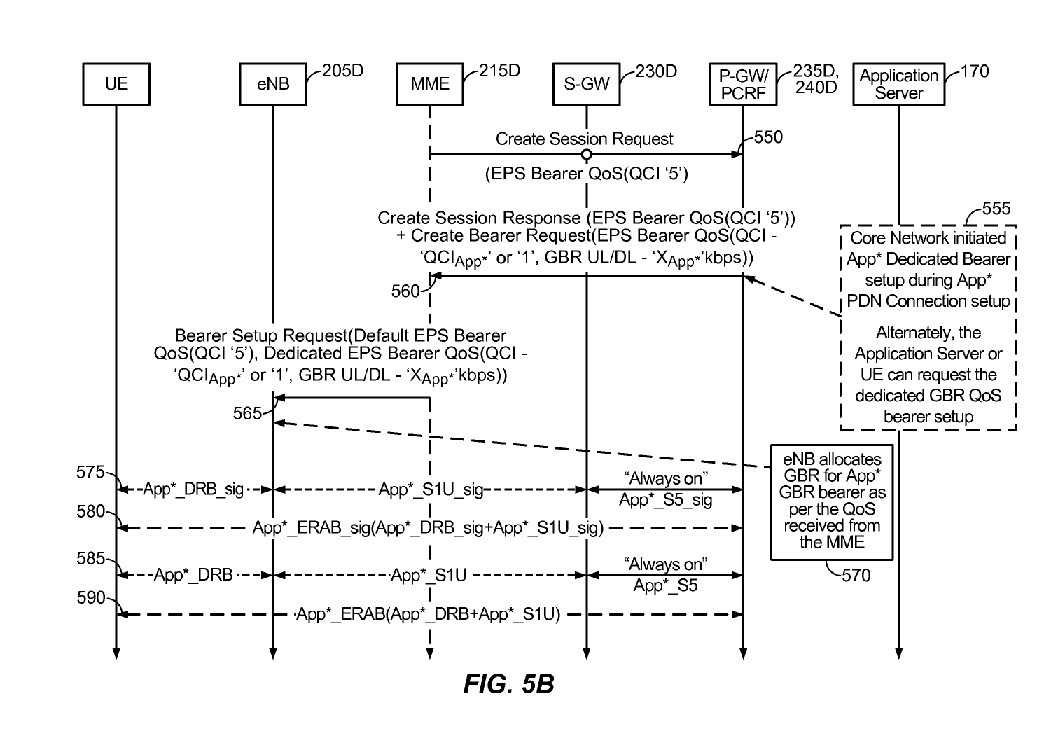

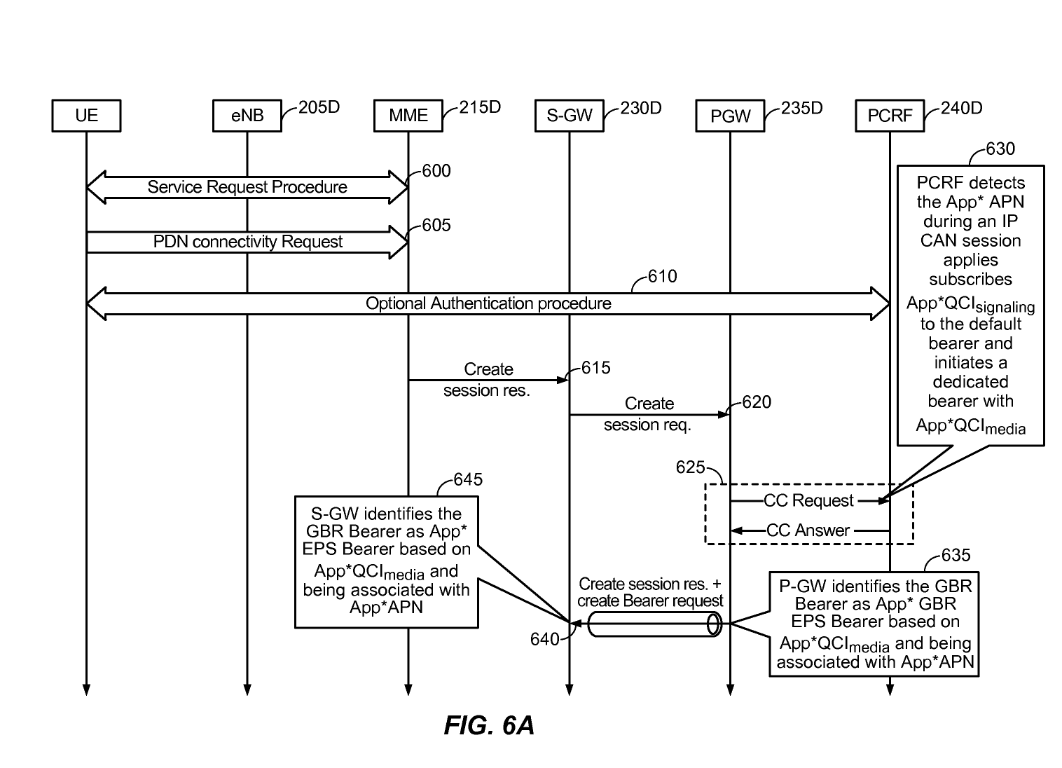

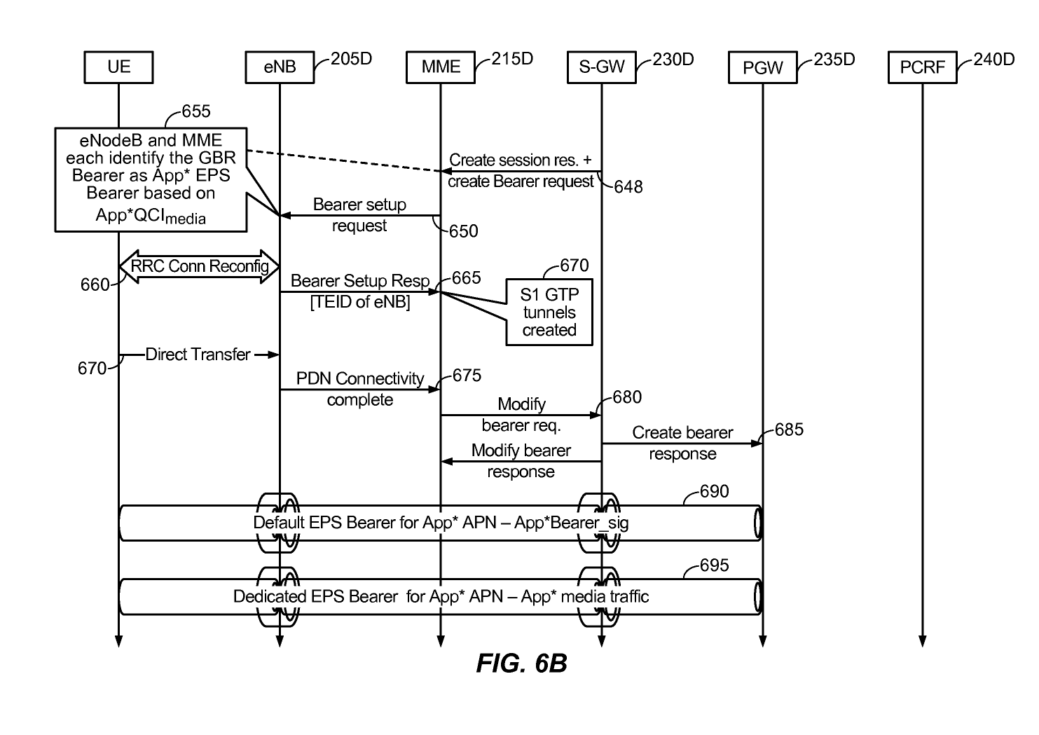

Below, FIGS. 5A-5B illustrate an ‘Always On’ QoS setup procedure for a particular GBR EPS bearer, and FIGS. 6A-6B show how the APN information can be exchanged during a QoS setup procedure for a particular GBR EPS bearer that is not ‘Always On’. Because the S-GW 230D and P-GW 235D are already provisioned with the APN information, and FIGS. 5A-5B illustrate a scenario where the S-GW 230D and P-GW 235D keep the App* GBR EPS bearer ‘Always On’, the propagation of the APN information to the eNodeB 205D (shown in FIGS. 6A-6B) is not strictly necessary for FIGS. 5A-5B. The App* identifying information in FIGS. 6A-6B can be exchanged via a reserved QCI (first embodiment), DSCP signaling (second embodiment) or an APN+QCI combination (third embodiment) in FIGS. 5A-6B.

FIGS. 5A-5B illustrate a process of setting up ‘Always On’ non-GBR and GBR EPS bearers in an LTE network in accordance with an embodiment of the invention. For example, the process of FIGS. 5A-5B can execute in the LTE environment shown above with respect to FIG. 2D, in an example.

Referring to FIG. 5A, 500 corresponds to an initial procedure whereby a given UE sets up a non-QoS EPS bearer. The setup of the non-QoS EPS bearer begins with the given UE in an RRC-Idle state, 505, after which a System Information reading operation is performed, 510, the Non-Access Stratum (NAS) layer at the given UE initiates EPS attach and PDN connectivity procedures, 515, the given UE and the LTE core network 140 engage in an RRC connection and context set-up procedure, 520, after which the given UE is transitioned into the RRC-Connected state, 525. At this point, a default EPS bearer (or non-GBR QoS EPS bearer) is established for the given UE, 530, and an ‘Always On’ S5 connection is set-up for the default EPS bearer, 535. The default EPS bearer can be used to support applications that exchange data for which QoS (e.g., GBR, etc.) is not required, such as web-browsing applications, Email applications, and so on.

The remainder of FIGS. 5A-5B describes setup of a GBR EPS bearer for a high-priority GBR application, which is denoted as App*. For LTE networks, App* can correspond to any application that requires GBR QoS on an associated EPS media bearer for supporting its communication sessions (e.g., PTT sessions, VoIP sessions, etc.) and that uses a dedicated Access Point Name (APN), where the dedicated APN is configured to specifically identify App* to external devices, such as components of the LTE core network 140. In non-LTE networks, App* can be supported on other types of QoS bearers.

Accordingly, after 535 of FIG. 5A, the given UE launches App*, 540, sends a PDN Connectivity Request for App* to the MME 215D, 545, and (turning to FIG. 5B) the MME 215D sends a Create Session Request to the P-GW/PCRF 235D/240D, 550. At this point, the LTE core network 140 can initiate set-up of the dedicated bearer for App*'s PDN connection, or alternatively the application server 170 or UE can request the dedicated GBR EPS bearer setup, 555. In either case, the P-GW/PCRF 235D/240D sends a Create Session Response message to the MME 215D which sets up the GBR EPS bearer with a GBR that is specific to App* (e.g., a nominal data rate such as 1 kpbs, or X_{App}* kpbs), 560. The MME 215D then delivers a Bearer Setup Request message to the eNodeB 215D to set-up the App*-specific GBR, 565, and the eNodeB 215D allocates the GBR for App*'s GBR EPS bearer as requested, 570. App*'s signaling bearer is setup, 575 and 580, and App*'s ‘Always On’ GBR EPS media bearer is also setup, 585 and 590.

Turning to App* in more detail, App*'s media traffic model can be configured differently than the typical VoIP application traffic. For example, App* can be configured to bundle at least one (e.g., 6) Vocoder frames into a single RTP packet and to transmit media packets every 120 ms. Thus, the data rate and air interface configurations required for the App* media bearer can be different than a VoIP media bearer, which is referenced as QCI ‘1’ in LTE networks. So, it may not be suitable to use QCI ‘1’ (conversational voice) for App*.

The LTE standard can reserve a QCI in the range 128-255 for certain multimedia applications (e.g., PTT applications), and can allocate GBR QoS for this QCI. The S-GW 230D and P-GW 235D can identify App*'s GBR EPS bearer during initial bearer setup or bearer setup due to x2 or S1 based handover based on the reserved QCI for App* (“App*QCI”, for signaling and/or media), or alternatively based upon QCI ‘1’ where the GBR EPS bearer is associated with an APN that is known to be related to App* (so the LTE core network knows to use App*'s specialized QoS parameters instead of the typical QCI ‘1’ QoS parameters). In an example, the recognition of the App*-specific GBR EPS bearer can be used to prompt the LTE network components (e.g., such as the MME 215D) to identify App*'s GBR EPS bearer and to perform actions based upon this recognition, such as selectively caching the GBR parameters for the GBR EPS bearer of a particular APN for quickly bringing up S5 connections after an RRC Idle-to-Connected transition. The eNodeB 205D can identify App*'s GBR EPS bearer during initial bearer setup bearer setup due to x2 or S1 based handover based on the reserved App*QCI to provide the requested QoS treatment. This procedure is shown in FIGS. 6A-6B.

Referring to FIG. 6A, the given UE, the eNodeB 205D and the MME 215D perform a service request procedure, 600, and the given UE delivers a PDN connectivity request for App* to the MME 215D, 605. Optionally, an authentication procedure can be performed for the given UE with the PCRF 240D, 610. The MME 215D delivers a Create Session Request to the S-GW 230D for App*, 615, and the S-GW 230D delivers a Create Session Request to the P-GW 235D for App*, 620. The P-GW 235D and the PCRF 240D then engage in an IP CAN session, 625, during which the PCRF 240D detects the App* APN, and applies App*QCI_{signaling} to the default bearer and initiates a dedicated bearer with App*QCI_{media}, 630.

Referring to FIG. 6A, the P-GW 235D identifies the GBR EPS Bearer as an App* EPS Bearer based on App*QCI_{media} and being associated with App*'s APN, 635. The P-GW 235D sends a Create Session Response+Create Bearer Request to the S-GW 230D that indicates App*QCI_{media}, 640. The S-GW 230D identifies the GBR EPS Bearer as an App*EPS Bearer based on App*QCI_{media} and being associated with App*'s APN, 645. Turning to FIG. 6B, the S-GW 230D sends a Create Session Response+Create Bearer Request to the MME 215D that indicates App*QCI_{media}, 648, and the MME 215D in turn sends a PDN Connectivity Accept+Dedicated Bearer Set Request message to the eNodeB 205D that indicates App*QCI_{media}, 650. The MME 215D and the eNodeB 205D identifies the GBR EPS Bearer as an App* EPS Bearer based on App*QCI_{media}, 655. The GBR EPS bearer for media is then setup with App*QCI_{media}, and the default EPS bearer for App*'s signaling is setup with App*QCI_{signaling}, as shown in the signaling between 660-695, which will be readily understood by one of ordinary skill in the art familiar with QoS setup in LTE networks.

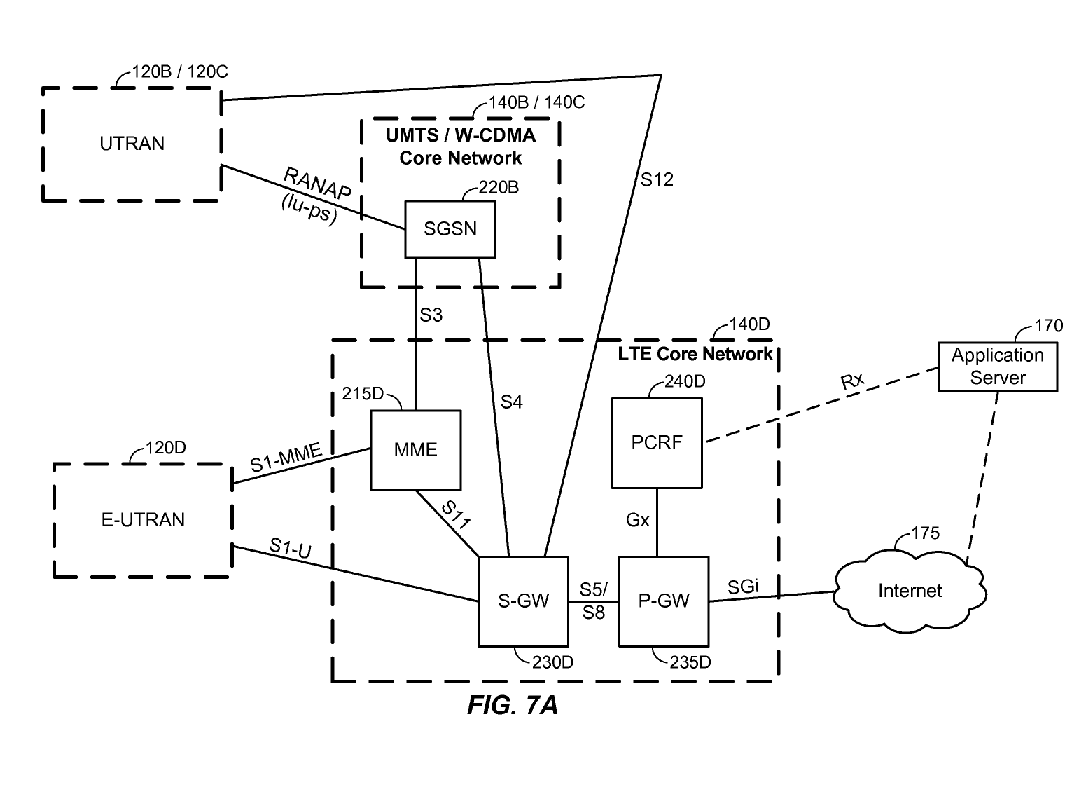

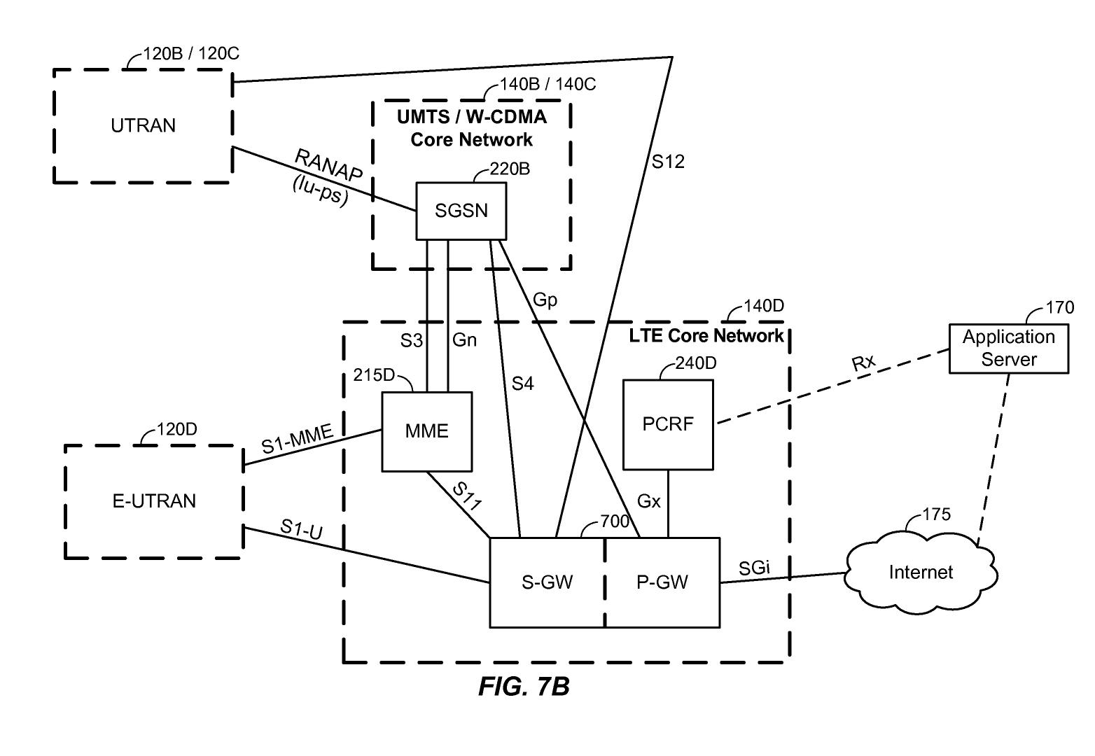

FIGS. 5A-5B and 6A-6B show different examples of how a GBR QoS bearer can be established for a particular application (App*) in an LTE network. However, during the course of a communication session over the LTE network while the UE is in RCC-Connected state and exchanging media using the App* GBR QoS bearer, conditions may prompt the UE to handoff from the LTE network to a non-LTE network, such as UMTS or W-CDMA (e.g., as in FIGS. 2B-2C). To facilitate handoffs between LTE and UMTS networks, interfaces or reference points (i.e., S3 and S4) are provided between the LTE core network and the UMTS core network, and an interface or reference point (i.e., S12) is also provided between the LTE core network and the UMTS RAN (or UTRAN). These interfaces are shown in FIGS. 7A-7B, which illustrate portions of the LTE core network from FIG. 2D as well as the UMTS or W-CDMA core network from FIGS. 2B-2C.

Referring to FIG. 7A, an LTE core network 140D and a UMTS core network 120B/120C are illustrated, which can correspond to the LTE core network 140 from FIG. 2D and the UTMS core networks for FIGS. 2B-2C, respectively. Not all components and/or interconnections associated with these respective core networks are illustrated in FIG. 7A to simplify its explanation. The respective RANs from FIGS. 2B-2D are illustrated as E-UTRAN 120D (for the LTE RAN 120 from FIG. 2D), and UTRAN 120B/120C (for either of the UMTS RANs 120 from FIGS. 2B-2C). In FIG. 7A, the MME 215D is connected to the SGSN 220B via an S3 interface, the S-GW 230D is connected to the SGSN 220B via an S4 interface, and the S-GW 230D is also directly connected to the UTRAN 120B/120C via an S12 interface. Alternatively, to connect the roaming UMTS SGSN to the MME in the home EPC, the Gn interface as specified between two Gn/Gp SGSNs, can be used. Additionally, the Gp Interface as specified between Gn/Gp SGSN and Gn/Gp GGSN can be used to connect the SGSN to the PGW.

FIG. 7B is similar to FIG. 7A except that the S-GW 230D and P-GW 235D are consolidated into a single component, denoted as 700 in FIG. 7B. Thus, FIG. 7B eliminates the S5 and/or S8 interfaces between the S-GW 230D and P-GW 235D by virtue of their consolidation. Aside from this consolidation, the other interfaces remain the same in FIG. 7B. Thus, any interface terminating at P-GW 235D in FIG. 2D or FIG. 7A terminates into the single component 700 instead in FIG. 7B, and any interface terminating at S-GW 230D in FIG. 2D or FIG. 7A terminates into the single component 700 instead in FIG. 7B

Below, communications are described as being exchanged (or tunneled) between UMTS and LTE networks. FIGS. 7A-7B show the interfaces (e.g., S3, S4, S12, etc.) on which these communications can be carried, even if these interfaces are not explicitly mentioned with respect to the embodiments below.

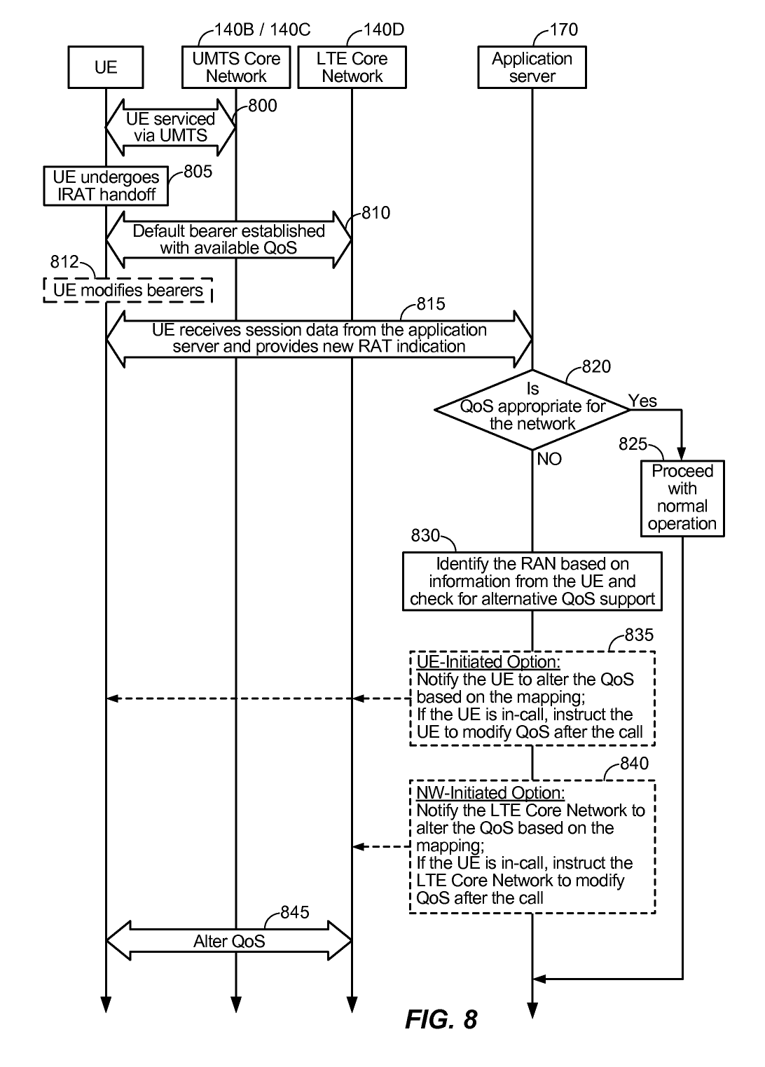

As will be appreciated by one of ordinary skill in the art, QoS parameters are different in HSPA (UMTS/W-CDMA) and LTE. During an Inter Radio Access Technology (IRAT) handoff between LTE and HSPA, the standard specifies mapping of QoS parameters so that equivalent QoS can be allocated on a media bearer in the target RAT for the handoff. For example, QCI ‘1’ in LTE may be mapped to a specific QoS class in UMTS via default QoS mapping tables. However, the default QoS mapping tables cannot accommodate applications (e.g., such as App*) that require customized QoS parameters (e.g., App*) that diverge from the preset QoS configurations supported by the default QoS mapping tables. Thus, an App* session supported by a particular App* QoS configuration on LTE may be substituted with a different QoS configuration upon handoff to UMTS, which may not be adequate to support an App* session. Likewise, an App* session supported by a particular App* QoS configuration on UMTS may be substituted with a different QoS configuration upon handoff to LTE, which may not be adequate to support the App* session. FIG. 8 illustrates an example whereby an App*-specific QoS configuration maintained on UMTS is not transferred to a corresponding media bearer on LTE after an IRAT handoff to LTE.

FIG. 8 illustrates a process of handing off a given UE engaged in a communication session via a GBR QoS bearer over the UMTS core network 140B/140C (e.g., a first RAT type) to the LTE core network 140D (e.g., a second radio access technology (RAT) type) in accordance with an embodiment of the invention. Referring to FIG. 8, the given UE is in CELL_FACH state or CELL_DCH state and is serviced by the UMTS core network 140B/140C for an App* communication session via the application server 170, 800. Thus, the given UE is allocated a GBR QoS bearer with an App*-specific QoS configuration, such as a GBR equal to X_{App}* kpbs. At some point during the App* communication session, the given UE hands off from the UTRAN 120B/120C of the UMTS core network 140B/140C to the E-UTRAN of the LTE core network 140D, 805. This handoff is between RANs with different RATs, and is referred to as an inter-RAT (IRAT) handoff. After the IRAT handoff, the given UE establishes a bearer on the LTE core network 140D with available QoS (e.g., QCI ‘1’), 810, the given UE can optionally modify its QoS allocation on its media bearer if UE-initiated QoS modifications are supported, 812, and the given UE begins to receive App* session media from the application server 170 via the LTE core network 140D (instead of the UTMS core network 140B/140C) and notifies the application server 170 of the given UE's new serving RAT (i.e., LTE) and its current QoS allocation, 815.

Referring to FIG. 8, the application server 170 determines whether the given UE's current QoS allocation in its new serving RAT (i.e., LTE) is sufficient for supporting the App* communication session, 820. If so, the application server 170 continues the App* communication session without modifying the given UE's QoS, 825. However, as noted above, App* may be associated with its own customized QoS configuration (e.g., GBR, etc.), and this customized QoS configuration may not have been adequately mapped from the UMTS core network to the LTE core network during the IRAT handoff at 805. For example, the QoS bearer may have been allocated X_{App}* kpbs on the UMTS network, which may be different from a GBR based on QCI ‘1’ after the IRAT handoff. Accordingly, if the application server 170 determines that the given UE's current QoS allocation in its new serving RAT (i.e., LTE) is insufficient for supporting the App* communication session at 820, the application server 170 identifies the RAT type of the serving RAN of the given UE to determine a target QoS (e.g., an App* QoS configuration for use in LTE networks), 830.

At this point, the application server 170 facilitates modification to the QoS on the given UE's media bearer (if not in-call). In particular, the application server 170 can facilitate a UE-initiated QoS adjustment procedure whereby the application server 170 transmits a message to the given UE that instructs the UE to modify the QoS on its media bearer immediately if the UE is not currently engaged in an App* communication session, or else to have the given UE to modify the QoS on its media bearer after the App* communication session is over (if in-call), 835. Alternatively, the application server 170 can facilitate a NW-initiated QoS adjustment procedure whereby the application server 170 sends a message to a component of the LTE core network 140 (e.g., MME 215D, etc.) that instructs the LTE network component to modify the QoS on the UE's media bearer immediately if the given UE is not currently engaged in an App* communication session, or else to have the LTE network component modify the QoS on the given UE's media bearer after the App* communication session is over (if in-call), 840. In an example, the application server 170's prompt for QoS modification at 835 and/or 840 is a fallback mechanism in the event that the given UE's QoS modification attempt at 812 is either not performed or is unsuccessful. At 845, and the App* client application (in response to 835) or the LTE network component (in response to 840) initiates the QoS modification for the given UE's media bearer via either a UE-initiated QoS modification procedure or a NW-initiated QoS modification procedure.

As will be appreciated from a review of FIG. 8, the application server 170 can attempt to prompt the given UE to modify its QoS allocation on a new RAT network after an IRAT handoff. However, embodiments of the invention are further directed to transferring the App* QoS configuration between RATs during an IRAT handoff while in-session.

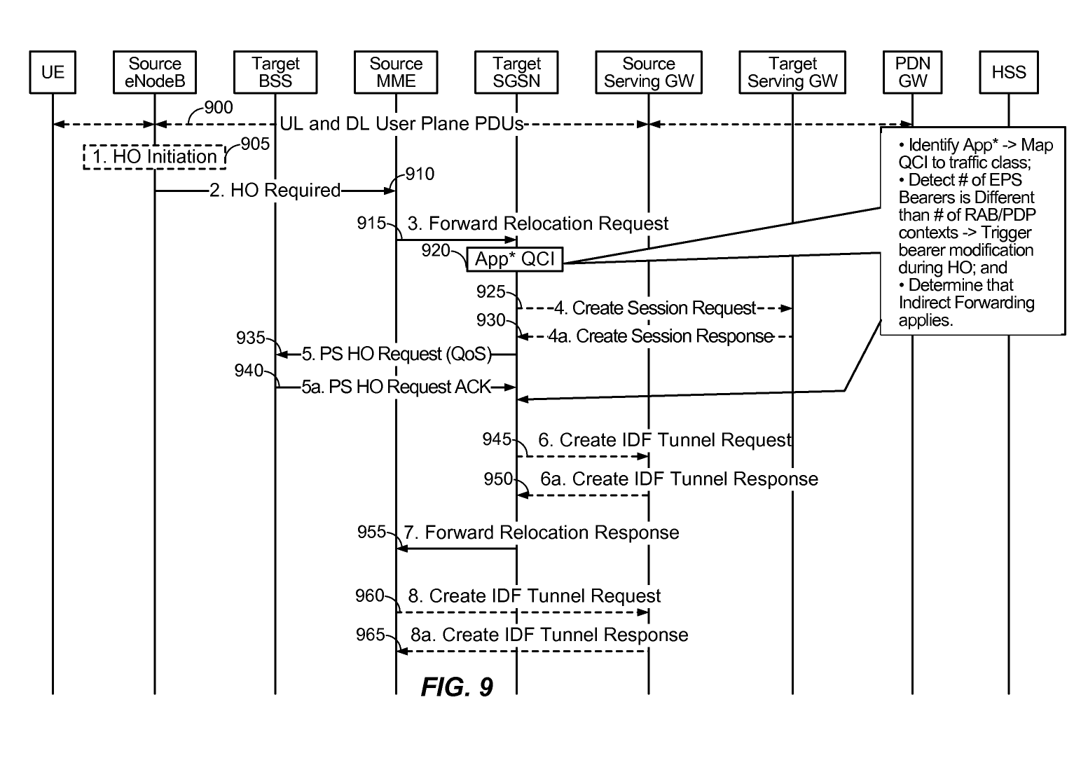

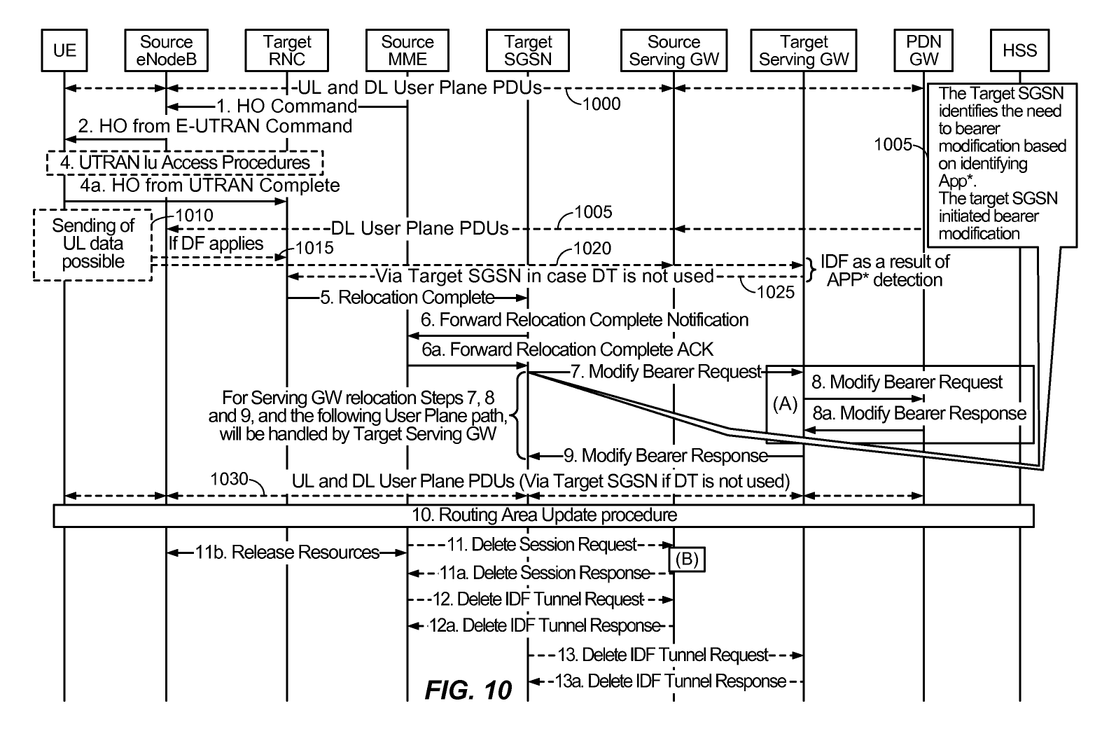

FIG. 9 illustrates a process of preparing for an LTE-to-UMTS (i.e., IRAT) handoff, and FIG. 10 illustrates a process of executing the LTE-to-UMTS handoff. In FIGS. 9 and 10, assume that the LTE and UMTS networks are connected via the interfaces shown in FIGS. 7A-7B (e.g., S3, S4, S12, Gn, Gp, etc.), and that the LTE core network referred to in FIGS. 9 and 10 corresponds to the LTE core network 140 from FIG. 2D (or shown in reduced form as LTE core network 140D in FIGS. 7A-7B), and that the UMTS core network referred to in FIGS. 9 and 10 corresponds to the UMTS core network 140 from FIG. 2B or FIG. 2C (or shown in reduced form as UMTS core network 140B/140C in FIGS. 7A-7B). Also, in FIGS. 9-10, a source S-GW and a target S-GW are described with respect to the IRAT handoff. However, it will be appreciated that certain IRAT handoffs do not necessarily change the S-GW, such that the source and target S-GWs can be the same S-GW in some implementations (e.g., if the source S-GW functions as a tunneling gateway to the RAN in the new RAT after the handoff). Thus, the source and target S-GWs can either correspond to the same S-GW or different S-GWs. In the case of a single S-GW, the single S-GW can replace the functionality of the GGSN via LTE-HSPA tunneling to simplify transitions between HSPA (or UMTS/W-CDMA) and LTE.

Referring to FIG. 9, packet data units (PDUs) are exchanged for the App* session over the LTE core network via an App* GBR EPS media bearer, 900 (e.g., after the App* GBR EPS media bearer is setup as in FIGS. 5A-5B or FIGS. 6A-6B). At 905, the source eNodeB 205D (i.e., the serving eNodeB 205D prior to the IRAT handoff) decides to initiate an IRAT handover to a target access network (i.e., UTRAN 120B/120C from FIG. 7) in Iu mode. At this point both uplink and downlink user data is transmitted via the following: Bearer(s) between UE and source eNodeB 205D, GTP tunnel(s) between source eNodeB 205D, S-GW 230D and P-GW 235D. At 910, the source eNodeB 205D sends a Handover Required message to the source MME 215D to request the UMTS core network to establish resources in the target RNC of the target UTRAN 120B/120C, the target SGSN 220B and the target S-GW 230D. At 910, the source MME 215D determines from the ‘Target RNC Identifier’ Information Element (IE) that the type of handover is IRAT Handover to UTRAN, and the source MME 215D initiates the Handover resource allocation procedure by sending a Forward Relocation Request message to the target SGSN. The Forward Relocation Request message lists all of EPS Bearer Contexts the relevant APNs and the QCIs.

Based on the Forward Relocation Request received at 915, the target SGSN 220B identifies that the list of EPS bearers that contain the App* based on a pre-provisioned APN+QCI mapping pre-provisioned at the SGSN 220B, 920. Alternatively App* could use an application specific QCI, 920. The target SGSN maps the EPS bearers to PDP contexts based on the identification of APP* and a predetermined mapping and maps the EPS Bearer QoS parameter values of an EPS bearer to the Release 99 QoS parameter values of a bearer context. Thus, irrespective of whether the App* identifying information is contained in the Forward Relocation Request message of 915 corresponds to a reserved QCI (first embodiment), DSCP signaling (second embodiment) or an APN+QCI combination (third embodiment), the target SGSN 220B is able to map the App* identifying information to a particular QoS configuration to be loaded on a bearer for supporting the App* session after the handoff at 920 of FIG. 9.

Moreover, at 920 of FIG. 9, the target SGSN 220B also identifies whether indirect forwarding or direct forwarding of the data is to be applied based on the a predetermined rule as applicable to App*. In the event that the number of bearers on the E-UTRAN and the UTRAN network are not symmetric, (e.g., the E-UTRAN uses a default and a dedicated bearer while the UTRAN network uses a single Primary PDP), the target SGSN 220B would be able to identify the direct or indirect forwarding aspect based on App* determination and would be able to request the appropriate bearer (at 925) or bearer mediation with the target S-GW 230D and the P-GW 235D during the handover execution phase (shown in FIG. 10).

Referring to FIG. 9, at 925, the target SGSN 220B determines a target S-GW and sends a Create Session Request message with the QCI value as determined based on the App* identifying information at 920 to the target S-GW. Also at 925, the target SGSN 220B establishes the EPS Bearer context(s) based on the App* identifying information at 920. At 930, the target S-GW allocates its local resources and returns a Create Session Response message to the target SGSN 220B. At 935, the target SGSN 220B requests the target RNC in the UTRAN 120B/120C to establish the radio network resources (RABs) by sending the message Relocation Request indicating the requisite Traffic class per RAB based on the mapping at the target SGSN 220B. At 940, the target RNC allocates the resources and returns the applicable parameters to the target SGSN 220B in the message Relocation Request Acknowledge.

Referring to FIG. 9, based on the determination at 920 using the App* identifying information, ‘Indirect Forwarding’ apply and Direct Tunnel is determined to be used, and the target SGSN 220B thereby sends a Create Indirect Data Forwarding Tunnel Request message to the target S-GW, 945. At 950, the target S-GW returns a Create Indirect Data Forwarding Tunnel message to the target SGSN 220B. At 955, the target SGSN 220B sends the message Forward Relocation Response to the source MME 215D, and the change indication field in the Forward Relocation Response indicates a new S-GW has been selected. At 960, because “Indirect Forwarding” applies, the Source MME 215D sends the message Create Indirect Data Forwarding Tunnel Request to the source S-GW used for indirect forwarding. At 965, the source S-GW returns the forwarding parameters by sending the message Create Indirect Data Forwarding Tunnel Response.

Referring to FIG. 10, assume that the process of FIG. 9 has already executed and that PDUs continue to be exchanged for the App* session over the LTE core network via the App* GBR EPS media bearer, 1000 (as in 900 of FIG. 9). Accordingly, at 1, the source MME 215D completes the IRAT handoff preparation phase by sending the source eNodeB the message Handover Command. At 2, the source eNodeB sends a command to the given UE to handover to the target access network via the message HO from E-UTRAN Command. At 4, the given UE moves to the target UTRAN Iu (3G UMTS) system and executes the handover. The indirect forwarding setup during the process of FIG. 9 provides user plane data continuity, which is shown in FIG. 10 by downlink user plane PDUs being received from the source S-GW, 1005, while the given UE can optionally transmit uplink data 1010, as shown at 1015. Otherwise, if direct forwarding is not used, the uplink and downlink data transmissions can occur via the target SGSN, 1020 and 1025.

Referring to FIG. 10, at 5, when the new source RNC-ID+S-RNTI are successfully exchanged with the given UE, the target RNC sends the Relocation Complete message to the target SGSN 220B. After the reception of the Relocation Complete message, the target SGSN is prepared to receive data from the target RNC. At 6, the target SGSN 220B informs the source MME 215D that it is prepared to receive data by sending the Forward Relocation Complete Notification message. At 6a, the source MME 215D responds to the Forward Relocation Complete Notification message with a Forward Relocation Complete Acknowledge message.

Referring to FIG. 10, at 7, the target SGSN 220B now completes the Handover procedure by informing the target S-GW that the target SGSN is now responsible for all the EPS Bearer Contexts the UE has established. This is performed in the message Modify Bearer Request per PDN connection. Alternatively, when bearer modifications are required as a result of mismatch between the bearers between the IRATs, the target SGSN 220B may initiate bearer modifications. The determination of whether bearer modifications are necessary is based on the target SGSN's recognition of the IRAT handoff being associated with a particular App* session based on the App* identifying information from 920 of FIG. 9. At 8, if the target S-GW determines that the bearers require modification based on the App* identifying information, the target S-GW may inform the PDN GW(s) the change of the RAT type that e.g. can be used for charging, by sending the message Modify Bearer Request per PDN connection. For example, at 8, if the target S-GW identifies that App* requires additional PDP contexts in the UTRAN network as compared to the existing EPS bearers in the E-UTRAN network, the S-GW sends the message Modify Bearer Request. The P-GW 235D acknowledges the user plane switch to the target SGSN with a Modify Bearer Response message. If Policy, Control and Charging (PCC) infrastructure is used, the P-GW 235D informs the PCRF 240D about the change of, for example, the RAT type.

Referring to FIG. 10, at 9, the target S-GW acknowledges the user plane switch to the target SGSN via the message Modify Bearer Response message. At this point, the user plane path is established for all EPS Bearer contexts between the given UE, the target RNC and the target SGSN, such that uplink and downlink user plane PDUs can be exchanged, 1030. At 10, the given UE and UTRAN complete the Routing Area Update (RAU) procedures. At 11, 11a and 11b, resources for the App* session on the source network for the handoff are released. At 12, 12a, 13 and 13a, if indirect forwarding was used then the source MME initiates a clean-up of the indirect forwarding tunnel.

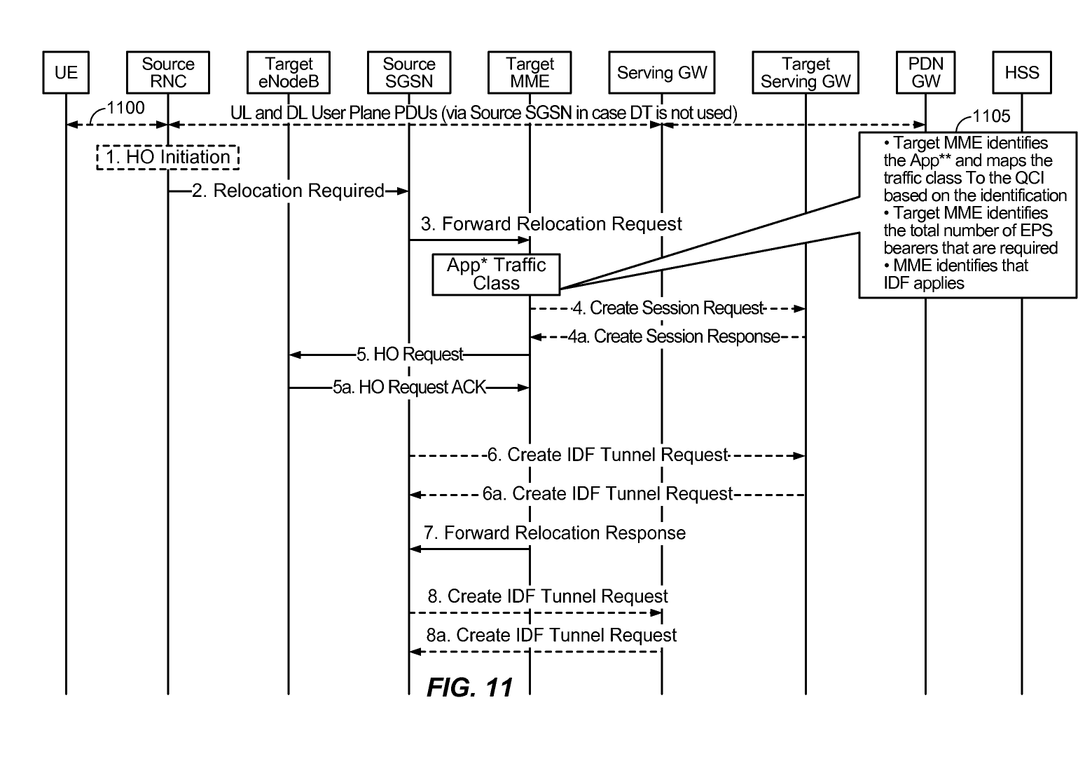

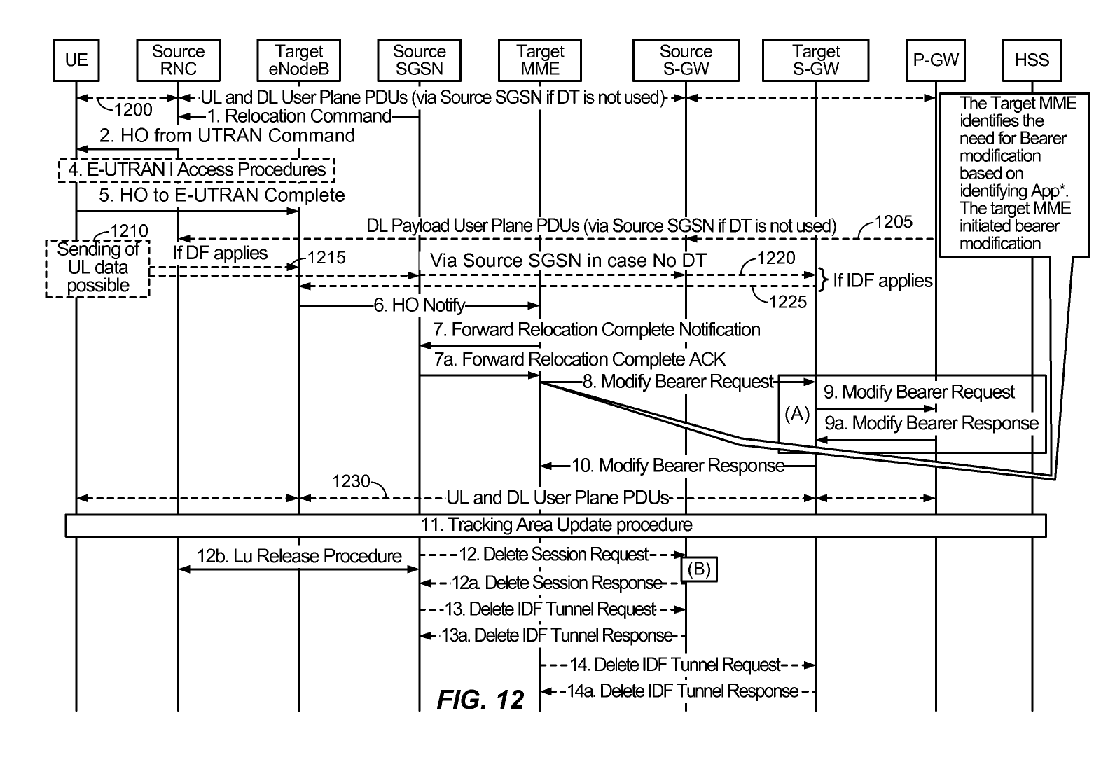

FIGS. 11 and 12 are similar to FIGS. 9 and 10 except that FIGS. 11 and 12 are directed to a UMTS-to-LTE handoff instead of an LTE-to-UMTS handoff (as in FIGS. 9 and 10). Accordingly, FIG. 11 is directed to a process of preparing for a UMTS-to-LTE (i.e., IRAT) handoff, and FIG. 12 illustrates a process of executing the UMTS-to-LTE handoff. In FIGS. 11 and 12, assume that the LTE and UMTS networks are connected via the interfaces shown in FIGS. 7A-7B (e.g., S3, S4, S12, etc.), and that the LTE core network referred to in FIGS. 11 and 12 corresponds to the LTE core network 140 from FIG. 2D (or shown in reduced form as LTE core network 140D in FIG. 7), and that the UMTS core network referred to in FIGS. 11 and 12 corresponds to the UMTS core network 140 from FIG. 2B or FIG. 2C (or shown in reduced form as UMTS core network 140B/140C in FIGS. 7A-7B). Also, in FIGS. 11-12, a source S-GW and a target S-GW are described with respect to the IRAT handoff. However, it will be appreciated that certain IRAT handoffs do not necessarily change the S-GW, such that the source and target S-GWs can be the same S-GW in some implementations (e.g., if the source S-GW functions as a tunneling gateway to the RAN in the new RAT after the handoff). Thus, the source and target S-GWs can either correspond to the same S-GW or different S-GWs. In the case of a single S-GW, the single S-GW can replace the functionality of the GGSN via LTE-HSPA tunneling to simplify transitions between HSPA (or UMTS/W-CDMA) and LTE.

Referring to FIG. 11, PDUs are exchanged for the App* session over the UMTS core network via an App* QoS media bearer, 1100 (e.g., after the App* QoS media bearer is setup as in FIGS. 5A-5B or FIGS. 6A-6B). In 1100, the PDUs can be exchanged for the App* session from the application server 170 through the LTE network and then to the UMTS core network via tunneling, as shown in FIGS. 7A-7B. At 1, the source RNC (i.e., the serving RNC prior to the IRAT handoff) decides to initiate an IRAT handover to a target access network (i.e., E-UTRAN 120D from FIGS. 7A-7B). At this point both uplink and downlink user data is transmitted via the following: Bearer(s) between UE and source RNC, GTP tunnel(s) between source RNC, source SGSN and source GGSN. At 2, the source RNC sends a Relocation Required message to the source SGSN to request the LTE core network to establish resources in the target S-GW and target MME of the target E-UTRAN 120D. At 3, the source SGSN determines from the Relocation Required message that the type of handover is IRAT Handover to E-UTRAN, and the source SGSN initiates the Handover resource allocation procedure by sending a Forward Relocation Request message to the target MME. The Forward Relocation Request message lists all of EPS Bearer Contexts the relevant APNs and the QCIs.

Referring to FIG. 11, based on the Forward Relocation Request received at 3, the target MME identifies that the list of EPS bearers that contain the App* based on a pre-provisioned APN+QCI mapping pre-provisioned at the MME, 1105. Alternatively App* could use an application specific QCI, 1105. The target MME maps the EPS bearers to PDP contexts based on the identification of App* and a predetermined mapping and maps the EPS Bearer QoS parameter values of the Release 99 QoS parameter values to a corresponding EPS bearer. Thus, irrespective of whether the App* identifying information is contained in the Forward Relocation Request message of 3 corresponds to a reserved QCI (first embodiment), DSCP signaling (second embodiment) or an APN+QCI combination (third embodiment), the target MME is able to map the App* identifying information to a particular QoS configuration to be loaded on a bearer for supporting the App* session after the handoff at 1105 of FIG. 11.

Moreover, at 1105 of FIG. 11, the target MME also identifies whether indirect forwarding or direct forwarding of the data is to be applied based on the a predetermined rule as applicable to App*. In the event that the number of bearers on the E-UTRAN and the UTRAN network are not symmetric, (e.g., the E-UTRAN uses a default and a dedicated bearer while the UTRAN network uses a single Primary PDP), the target MME would be able to identify the direct or indirect forwarding aspect based on App* determination and would be able to request the appropriate bearer (at 4 of FIG. 11) or bearer mediation during the handover execution phase (shown in FIG. 12).

Referring to FIG. 11, at 4, the target MME determines a target S-GW and sends a Create Session Request message with the QCI value as determined based on the App* identifying information at 1105 to the target S-GW. Also at 4, the target MME establishes the EPS Bearer context(s) based on the App* identifying information at 1105. At 4a, the target S-GW allocates its local resources and returns a Create Session Response message to the target MME. At 5, the target MME requests the target eNodeB in the E-UTRAN 120D to establish the GBR EPS bearers by sending the Handover Request message indicating the requisite QCI (e.g., App* QCI) per RAB based on the mapping at the target MME. At 5a, the target eNodeB allocates the resources and returns the applicable parameters to the target MME in the message Handover Request Acknowledge.

Referring to FIG. 11, at 6, based on the determination at 1105 using the App* identifying information, ‘Indirect Forwarding’ apply and Direct Tunnel is determined to be used, and the target MME thereby sends a Create Indirect Data Forwarding Tunnel Request message to the target S-GW. At 6a, the target S-GW returns a Create Indirect Data Forwarding Tunnel message to the target MME. At 7, the target MME sends the message Forward Relocation Response to the source SGSN, and the change indication field in the Forward Relocation Response indicates a new S-GW has been selected. At 8, because “Indirect Forwarding” applies, the source SGSN sends the message Create Indirect Data Forwarding Tunnel Request to the source S-GW used for indirect forwarding. At 8a, the source S-GW returns the forwarding parameters by sending the message Create Indirect Data Forwarding Tunnel Response back to the source SGSN.

Referring to FIG. 12, assume that the process of FIG. 11 has already executed and that PDUs continue to be exchanged for the App* session over the UMTS core network via the App* QoS media bearer, 1200 (as in 1100 of FIG. 11). Accordingly, at 1, the source SGSN completes the IRAT handoff preparation phase by sending the source RNC the message Relocation Command. At 2, the source RNC sends a command to the given UE to handover to the target access network via the message HO from UTRAN Command. At 4, the given UE moves to the target E-UTRAN Iu (LTE) system and executes the handover, which completes at 5. The indirect forwarding setup during the process of FIG. 11 provides user plane data continuity, which is shown in FIG. 12 by downlink user plane PDUs being received from the source S-GW, 1205, while the given UE can optionally transmit uplink data 1210, as shown at 1215. Otherwise, if direct forwarding is not used, the uplink and downlink data transmissions can occur via the source SGSN, 1220 and 1225.

Referring to FIG. 12, at 6, the target eNodeB sends the Handover Notify message to the target MME. After the reception of the Handover Notify message, the target MME is prepared to receive data from the target eNodeB. At 7, the target MME informs the source SGSN that it is prepared to receive data by sending the Forward Relocation Complete Notification message. At 7a, the source SGSN responds to the Forward Relocation Complete Notification message with a Forward Relocation Complete Acknowledge message.

Referring to FIG. 12, at 8, the target MME now completes the Handover procedure by informing the target S-GW that the target MME is now responsible for all the EPS Bearer Contexts the UE has established. This is performed in the message Modify Bearer Request per PDN connection. Alternatively, when bearer modifications are required as a result of mismatch between the bearers between the IRATs, the target MME may initiate bearer modifications. The determination of whether bearer modifications are necessary is based on the target MME's recognition of the IRAT handoff being associated with a particular App* session based on the App* identifying information from 1105 of FIG. 11. At 9, if the target S-GW determines that the bearers require modification based on the App* identifying information, the target S-GW may inform the PDN GW(s) the change of the RAT type that e.g. can be used for charging, by sending the message Modify Bearer Request per PDN connection. For example, at 9, if the target S-GW identifies that App* requires additional EPS bearers in the E-UTRAN network as compared to the existing PDP contexts in the UTRAN network, the S-GW sends the message Modify Bearer Request. The P-GW 235D acknowledges the user plane switch to the target MME with a Modify Bearer Response message. If PCC infrastructure is used, the P-GW 235D informs the PCRF 240D about the change of, for example, the RAT type.

Referring to FIG. 12, at 10, the target S-GW acknowledges the user plane switch to the target MME via the message Modify Bearer Response message. At this point, the user plane path is established for all EPS Bearer contexts between the given UE, the target eNodeB and the target MME, such that uplink and downlink user plane PDUs can be exchanged, 1230. At 11, the given UE and E-UTRAN complete the RAU procedures. At 12, 12a and 12b, resources for the App* session on the source network for the handoff are released. At 13, 13a, 14 and 14a, if indirect forwarding was used then the source SGSN initiates a clean-up of the indirect forwarding tunnel.

While the embodiments above have been described primarily with reference to GPRS architecture in W-CDMA or UMTS networks and/or EPS architecture in LTE-based networks, it will be appreciated that other embodiments can be directed to other types of network architectures and/or protocols.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a user equipment (UE), comprising:
maintaining a first channel via a first network with a first radio access technology (RAT) type, the first channel allocated a first level of Quality of Service (QoS);
handing off from the first network to a second network with a second RAT type that is different from the first RAT type;
obtaining a second channel from the second network in conjunction with the handoff, the second channel allocated a second level of QoS;
reporting the second level of QoS to a server that is external to the first and second networks and is configured to arbitrate communication sessions for the UE; and
receiving a set of instructions from the server to modify the second level of QoS on the second channel in response to the report.

2. The method of claim 1, further comprising:
performing a UE-initiated QoS adjustment procedure with the second network in response to the received set of instructions to transition the second level of QoS on the second channel to the first level of QoS or a third level of QoS.

3. The method of claim 2,
wherein the handoff occurs during a communication session that is supported by the first channel before the handoff and is supported by the second channel after the handoff, and
wherein the UE-initiated QoS adjustment procedure is delayed after the communication session is terminated.

4. The method of claim 2,
wherein the handoff occurs when the first channel is not supporting a communication session, and
wherein the UE-initiated QoS adjustment procedure is performed without delay.

5. The method of claim 1, wherein the first RAT type is Universal Mobile Telecommunications System (UMTS) and the second RAT type is Long Term Evolution (LTE).

6. A method of operating a network component of a target network, comprising:
establishing, in conjunction with a handoff of a user equipment (UE) from a source network with a first radio access technology (RAT) type that is different from a second RAT type of the target network, a channel that is assigned to the UE with a given level of Quality of Service (QoS);
receiving, from the UE, a report that indicates the given level of QoS;
forwarding the report to a server that is external to the source and target networks and is configured to arbitrate communication sessions for the UE; and
receiving a set of instructions from the server that is external to the source and target networks to modify the given level of QoS on the channel in response to the forwarded report.

7. The method of claim 6, further comprising:
performing a network-initiated QoS adjustment procedure in response to the received set of instructions to transition the given level of QoS on the channel to a different level of QoS.

8. The method of claim 7,
wherein the handoff occurs during a communication session that is supported by a given channel on the source network before the handoff and is supported by the channel after the handoff, and
wherein the network-initiated QoS adjustment procedure is delayed after the communication session is terminated.

9. The method of claim 7,
wherein the handoff occurs when the first channel is not supporting a communication session, and
wherein the network-initiated QoS adjustment procedure is performed without delay.

10. The method of claim 6, wherein the first RAT type is Universal Mobile Telecommunications System (UMTS) and the second RAT type is Long Term Evolution (LTE).

11. A method of operating a server that is configured to arbitrate a given type of communication session, comprising:
determining at the server that a user equipment (UE) has handed off from a first network with a first radio access technology (RAT) type to a second network with a second RAT type and that the UE has been allocated a channel with a first level of Quality of Service (QoS) by the second network, wherein the server is external to the first and second networks;
determining whether the first level of QoS is sufficient for supporting the given type of communication session;
permitting the UE to use the channel for engaging in the given type of communication session without QoS modification if the determining determines that the first level of QoS is sufficient; and
delivering a set of instructions to an apparatus that requests the apparatus to modify the first level of QoS on the channel to a second level of QoS if the determining determines that the first level of QoS is insufficient.

12. The method of claim 11,
wherein the apparatus corresponds to the UE, and
wherein the set of instructions is configured to trigger the UE to perform a UE-initiated QoS adjustment procedure for modifying the first level of QoS on the channel to the second level of QoS.

13. The method of claim 11,
wherein the apparatus corresponds to a network component of the second network, and
wherein the set of instructions is configured to trigger the network component of the second network to perform a network-initiated QoS adjustment procedure for modifying the first level of QoS on the channel to the second level of QoS.

14. The method of claim 11, wherein the first RAT type is Universal Mobile Telecommunications System (UMTS) and the second RAT type is Long Term Evolution (LTE).

15. The method of claim 11, wherein the determination of whether the first level of QoS is sufficient for supporting the given type of communication session includes identifying a set of application-specific QoS requirements for the given type of communication session, and comparing the identified set of application-specific QoS requirements with the first level of QoS.

16. A method of operating a network component of a first network with a first radio access technology (RAT) type that is serving a user equipment (UE) undergoing a handoff to a second network with a second RAT type, comprising:
determining to handoff the UE from the first network to the second network while the UE is being supported by the first network with a first set of channels having a first application-specific Quality of Service (QoS) configuration that is mapped to an application of a given type, the application of the given type corresponding to a non-Internet Protocol (IP) Multimedia Subsystem (IMS) application; and
transmitting a handoff preparation message to the second network that identifies the application of the given type to facilitate the second network to initiate setup of a second set of channels with a second application-specific QoS configuration for the UE on the second network in conjunction with the handoff.

17. The method of claim 16, wherein the handoff preparation message identifies the application of the given type (i) by attaching a QoS Class Indicator (QCI) that is reserved for the application of the given type, (ii) via DiffServ Code Point (DSCP) signaling and/or (iii) by attaching a combination of QCI and access point name (APN) information.

18. The method of claim 16, wherein the first RAT type is Long Term Evolution (LTE) and the second RAT type is Universal Mobile Telecommunications System (UMTS).

19. The method of claim 18,
wherein the network component corresponds to a source Mobility Management Entity (MME) of the first network, and
wherein the handoff preparation message corresponds to a Forward Relocation Request message that is sent from the source MME to a target Serving GRPS Support Node (SGSN) of the second network.

20. The method of claim 16, wherein the first RAT type is Universal Mobile Telecommunications System (UMTS) and the second RAT type is Long Term Evolution (LTE).

21. The method of claim 20,
wherein the network component corresponds to a source Serving GRPS Support Node (SGSN) of the first network, and
wherein the handoff preparation message corresponds to a Forward Relocation Request message that is sent from the source SGSN to a target Mobility Management Entity (MME) of the second network.

22. A method of operating a network component of a first network with a first radio access technology (RAT) type that is a target of a handoff for a user equipment (UE) being served by a second network with a second RAT type, comprising:
receiving a handoff preparation message from the first network that identifies an application of the given type, the application of the given type corresponding to a non-Internet Protocol (IP) Multimedia Subsystem (IMS) application;
identifying an application-specific Quality of Service (QoS) configuration that is mapped to the application of the given type based on the identification of the application of the given type from the handoff preparation message; and
setting up a set of channels with the identified application-specific QoS configuration for the UE on the second network in conjunction with the handoff.

23. The method of claim 22, wherein the handoff preparation message identifies the application of the given type (i) by attaching a QoS Class Indicator (QCI) that is reserved for the application of the given type, (ii) via DiffServ Code Point (DSCP) signaling and/or (iii) by attaching a combination of QCI and access point name (APN) information.

24. The method of claim 22, wherein the first RAT type is Long Term Evolution (LTE) and the second RAT type is Universal Mobile Telecommunications System (UMTS).

25. The method of claim 24,
wherein the network component corresponds to a target Mobility Management Entity (MME) of the first network, and
wherein the handoff preparation message corresponds to a Forward Relocation Request message that is sent to the target MME from a source Serving GRPS Support Node (SGSN) of the second network.

26. The method of claim 22, wherein the first RAT type is Universal Mobile Telecommunications System (UMTS) and the second RAT type is Long Term Evolution (LTE).

27. The method of claim 26,
wherein the network component corresponds to a target Serving GRPS Support Node (SGSN) of the first network, and
wherein the handoff preparation message corresponds to a Forward Relocation Request message that is sent to the target SGSN to a source Mobility Management Entity (MME) of the second network.

28. A user equipment (UE), comprising:
means for maintaining a first channel via a first network with a first radio access technology (RAT) type, the first channel allocated a first level of Quality of Service (QoS);
means for handing off from the first network to a second network with a second RAT type that is different from the first RAT type;
means for obtaining a second channel from the second network in conjunction with the handoff, the second channel allocated a second level of QoS;
means for reporting the second level of QoS to a server that is external to the first and second networks and is configured to arbitrate communication sessions for the UE; and
means for receiving a set of instructions from the server to modify the second level of QoS on the second channel in response to the report.

29. A network component of a target network, comprising:
means for establishing, in conjunction with a handoff of a user equipment (UE) from a source network with a first radio access technology (RAT) type that is different from a second RAT type of the target network, a channel that is assigned to the UE with a given level of Quality of Service (QoS);
means for receiving, from the UE, a report that indicates the given level of QoS;
means for forwarding the report to a server that is external to the source and target networks and is configured to arbitrate communication sessions for the UE; and
means for receiving a set of instructions from the server that is external to the source and target networks to modify the given level of QoS on the channel in response to the forwarded report.

30. A server that is configured to arbitrate a given type of communication session, comprising:
means for determining at the server that a user equipment (UE) has handed off from a first network with a first radio access technology (RAT) type to a second network with a second RAT type and that the UE has been allocated a channel with a first level of Quality of Service (QoS) by the second network, wherein the server is external to the first and second networks;
means for determining whether the first level of QoS is sufficient for supporting the given type of communication session;
means for permitting the UE to use the channel for engaging in the given type of communication session without QoS modification if the determining determines that the first level of QoS is sufficient; and
means for delivering a set of instructions to an apparatus that requests the apparatus to modify the first level of QoS on the channel to a second level of QoS if the determining determines that the first level of QoS is insufficient.

31. A network component of a first network with a first radio access technology (RAT) type that is serving a user equipment (UE) undergoing a handoff to a second network with a second RAT type, comprising:
means for determining to handoff the UE from the first network to the second network while the UE is being supported by the first network with a first set of channels having a first application-specific Quality of Service (QoS) configuration that is mapped to an application of a given type, the application of the given type corresponding to a non-Internet Protocol (IP) Multimedia Subsystem (IMS) application; and
means for transmitting a handoff preparation message to the second network that identifies the application of the given type to facilitate the second network to initiate setup of a second set of channels with a second application-specific QoS configuration for the UE on the second network in conjunction with the handoff.

32. A network component of a first network with a first radio access technology (RAT) type that is a target of a handoff for a user equipment (UE) being served by a second network with a second RAT type, comprising:
means for receiving a handoff preparation message from the first network that identifies an application of the given type, the application of the given type corresponding to a non-Internet Protocol (IP) Multimedia Subsystem (IMS) application;
means for identifying an application-specific Quality of Service (QoS) configuration that is mapped to the application of the given type based on the identification of the application of the given type from the handoff preparation message; and
means for setting up a set of channels with the identified application-specific QoS configuration for the UE on the second network in conjunction with the handoff.

33. A user equipment (UE), comprising:
logic configured to maintain a first channel via a first network with a first radio access technology (RAT) type, the first channel allocated a first level of Quality of Service (QoS);
logic configured to hand off from the first network to a second network with a second RAT type that is different from the first RAT type;
logic configured to obtain a second channel from the second network in conjunction with the handoff, the second channel allocated a second level of QoS;
logic configured to report the second level of QoS to a server that is external to the first and second networks and is configured to arbitrate communication sessions for the UE; and
logic configured to receive a set of instructions from the server to modify the second level of QoS on the second channel in response to the report.

34. A network component of a target network, comprising:
logic configured to establish, in conjunction with a handoff of a user equipment (UE) from a source network with a first radio access technology (RAT) type that is different from a second RAT type of the target network, a channel that is assigned to the UE with a given level of Quality of Service (QoS);
logic configured to receive, from the UE, a report that indicates the given level of QoS;
logic configured to forward the report to a server that is external to the source and target networks and is configured to arbitrate communication sessions for the UE; and
logic configured to receive a set of instructions from the server that is external to the source and target networks to modify the given level of QoS on the channel in response to the forwarded report.

35. A server that is configured to arbitrate a given type of communication session, comprising:
logic configured to determine at the server that a user equipment (UE) has handed off from a first network with a first radio access technology (RAT) type to a second network with a second RAT type and that the UE has been allocated a channel with a first level of Quality of Service (QoS) by the second network, wherein the server is external to the first and second networks;
logic configured to determine whether the first level of QoS is sufficient for supporting the given type of communication session;
logic configured to permit the UE to use the channel for engaging in the given type of communication session without QoS modification if the determining determines that the first level of QoS is sufficient; and
logic configured to deliver a set of instructions to an apparatus that requests the apparatus to modify the first level of QoS on the channel to a second level of QoS if the determining determines that the first level of QoS is insufficient.

36. A network component of a first network with a first radio access technology (RAT) type that is serving a user equipment (UE) undergoing a handoff to a second network with a second RAT type, comprising:
logic configured to determine to handoff the UE from the first network to the second network while the UE is being supported by the first network with a first set of channels having a first application-specific Quality of Service (QoS) configuration that is mapped to an application of a given type, the application of the given type corresponding to a non-Internet Protocol (IP) Multimedia Subsystem (IMS) application; and
logic configured to transmit a handoff preparation message to the second network that identifies the application of the given type to facilitate the second network to initiate setup of a second set of channels with a second application-specific QoS configuration for the UE on the second network in conjunction with the handoff.

37. A network component of a first network with a first radio access technology (RAT) type that is a target of a handoff for a user equipment (UE) being served by a second network with a second RAT type, comprising:
logic configured to receive a handoff preparation message from the first network that identifies an application of the given type, the application of the given type corresponding to a non-Internet Protocol (IP) Multimedia Subsystem (IMS) application;
logic configured to identify an application-specific Quality of Service (QoS) configuration that is mapped to the application of the given type based on the identification of the application of the given type from the handoff preparation message; and
logic configured to set up a set of channels with the identified application-specific QoS configuration for the UE on the second network in conjunction with the handoff.

38. A non-transitory computer-readable medium containing instructions stored thereon, which, when executed by a user equipment (UE), cause the UE to perform operations, the instructions comprising:
at least one instruction to cause the UE to maintain a first channel via a first network with a first radio access technology (RAT) type, the first channel allocated a first level of Quality of Service (QoS);
at least one instruction to cause the UE to hand off from the first network to a second network with a second RAT type that is different from the first RAT type;
at least one instruction to cause the UE to obtain a second channel from the second network in conjunction with the handoff, the second channel allocated a second level of QoS;
at least one instruction to cause the UE to report the second level of QoS to a server that is external to the first and second networks and is configured to arbitrate communication sessions for the UE; and
at least one instruction to cause the UE to receive a set of instructions from the server to modify the second level of QoS on the second channel in response to the report.

39. A non-transitory computer-readable medium containing instructions stored thereon, which, when executed by a network component of a target network, cause the network component to perform operations, the instructions comprising:
at least one instruction to cause the network component to establish, in conjunction with a handoff of a user equipment (UE) from a source network with a first radio access technology (RAT) type that is different from a second RAT type of the target network, a channel that is assigned to the UE with a given level of Quality of Service (QoS);
at least one instruction to cause the network component to receive, from the UE, a report that indicates the given level of QoS;
at least one instruction to cause the network component to forward the report to a server that is external to the source and target networks and is configured to arbitrate communication sessions for the UE; and
at least one instruction to cause the network component to receive a set of instructions from the server that is external to the source and target networks to modify the given level of QoS on the channel in response to the forwarded report.

40. A non-transitory computer-readable medium containing instructions stored thereon, which, when executed by a server that is configured to arbitrate a given type of communication session, cause the server to perform operations, the instructions comprising:
at least one instruction to cause the server to determine at the server that a user equipment (UE) has handed off from a first network with a first radio access technology (RAT) type to a second network with a second RAT type and that the UE has been allocated a channel with a first level of Quality of Service (QoS) by the second network, wherein the server is external to the first and second networks;
at least one instruction to cause the server to determine whether the first level of QoS is sufficient for supporting the given type of communication session;
at least one instruction to cause the server to permit the UE to use the channel for engaging in the given type of communication session without QoS modification if the determining determines that the first level of QoS is sufficient; and
at least one instruction to cause the server to deliver a set of instructions to an apparatus that requests the apparatus to modify the first level of QoS on the channel to a second level of QoS if the determining determines that the first level of QoS is insufficient.

41. A non-transitory computer-readable medium containing instructions stored thereon, which, when executed by a network component of a first network with a first radio access technology (RAT) type that is serving a user equipment (UE) undergoing a handoff to a second network with a second RAT type, cause the network component to perform operations, the instructions comprising:
at least one instruction to cause the network component to determine to handoff the UE from the first network to the second network while the UE is being supported by the first network with a first set of channels having a first application-specific Quality of Service (QoS) configuration that is mapped to an application of a given type, the application of the given type corresponding to a non-Internet Protocol (IP) Multimedia Subsystem (IMS) application; and
at least one instruction to cause the network component to transmit a handoff preparation message to the second network that identifies the application of the given type to facilitate the second network to initiate setup of a second set of channels with a second application-specific QoS configuration for the UE on the second network in conjunction with the handoff.

42. A non-transitory computer-readable medium containing instructions stored thereon, which, when executed by a network component of a first network with a first radio access technology (RAT) type that is a target of a handoff for a user equipment (UE) being served by a second network with a second RAT type, cause the network component to perform operations, the instructions comprising:
at least one instruction to cause the network component to receive a handoff preparation message from the first network that identifies an application of the given type, the application of the given type corresponding to a non-Internet Protocol (IP) Multimedia Subsystem (IMS) application;
at least one instruction to cause the network component to identify an application-specific Quality of Service (QoS) configuration that is mapped to the application of the given type based on the identification of the application of the given type from the handoff preparation message; and
at least one instruction to cause the network component to set up a set of channels with the identified application-specific QoS configuration for the UE on the second network in conjunction with the handoff.
